(19) United States
(12) Patent Application Publication
(10) Pub. No.: US 2004/0260682 A1
(43) Pub. Date: Dec. 23, 2004

(54) System and method for identifying content and managing information corresponding to objects in a signal

(75) Inventors: Cormac Herley, Bellevue, WA (US); Chris Burges, Bellevue, WA (US); Erin Renshaw, Kirkland, WA (US)

Correspondence Address: Mark A. Watson, Lyon & Harr, Suite 800, 300 Esplanade Drive, Oxnard, CA, 93030, US

(73) Assignee: Microsoft Corporation, Redmond, WA

(21) Appl. No.: 10/600,589

(22) Filed: Jun. 19, 2003

(51) Int. Cl. G06F 7/00

(52) U.S. Cl. 707/3

(57) ABSTRACT

An “interactive signal analyzer” provides a framework for sampling one or more signals, such as, for example, one or more channels across the entire FM radio spectrum in one or more geographic regions, to identify objects of interest within the signal content and associate attributes with that content. The interactive signal analyzer uses a signal fingerprint extraction algorithm, i.e., a “fingerprint engine,” for deriving traces from segments of one or more signals. These traces are referred to as “fingerprints” since they are used to uniquely identify the signal segments from which they are derived. These fingerprints are then used for comparison to a database of fingerprints of known objects of interest. Information describing the identified content and associated object attributes is then provided in an interactive user database for viewing and interacting with information resulting from the comparison of the fingerprints to the database.

### BACKGROUND

1. Technical Field

The invention is related to a system for identifying content of a signal, and in particular, to a system and method for sampling one or more channels of a broadcast spectrum, such as a radio frequency spectrum, identifying and storing content information for each sampled channel, and providing a user interface for allowing interactive user queries and display of the stored content information.

2. Related Art

There are a number of existing schemes for identifying “objects” of interest within a signal. For example, audio objects such as particular advertisements, station jingles, or songs embedded in an audio stream, advertisements or other videos embedded in a video stream, or even a pattern indicating a heart arrhythmia in an electrocardiogram signal may represent objects of interest. Clearly, any type of signal may include objects of interest for which automatic identification would be useful.

One common method for automatically identifying such objects involves analyzing an input signal, or a predefined portion or segment of such a signal, to produce a set of parameters or features that are derived from the signal. These parameters or features are then stored as “fingerprints” that uniquely identify such objects. These fingerprints may then be used to identify subsequent occurrences of objects in a similar signal.

For example, in an audio signal, such features may include the mel cepstra, the zero crossing rate, energy measures, spectral component measures, and derivatives of these quantities. Clearly, other signal types, including video signals, electrocardiograms, acceleration data signals, etc., make use of other heuristic features that are specific to the particular type of signal being analyzed.

Once computed, these fingerprints are typically stored in a database of known objects. Sampled portions of a signal are then compared to the fingerprints in the database for identification purposes. In operation, such schemes often sample the signal over a desired period using some sort of sliding window arrangement, and compare the sampled data to the database in order to identify potential matches. In this manner, individual objects in the signal can be reliably identified. This identification information is then used for any of a number of purposes, including segmentation of the signal into discrete objects, or generation of play lists or the like for cataloging a media stream type signal.

With conventional fingerprinting schemes, once objects have been identified within a signal such as a broadcast media stream, information describing those objects is often stored to a database or provided in a predefined format to a user. For example, such information may be used to identify the time that a particular commercial played on a particular television station that is being monitored. Such schemes typically provide only limited interaction with the information associated with objects identified within the signal. Further, such schemes are not typically designed to simultaneously operate across multiple signals or channels of a broadcast spectrum.

Therefore, what is needed is a system and method for identifying objects in one or more signals through a comparison to a database of known object fingerprints. In conjunction with this identification, statistical information for describing identified objects should also be stored for either real-time or subsequent use. Further, such a system and method should provide a robust user interface for allowing user queries, interaction, and management of the identified objects and object information.

### SUMMARY

A system and method for providing automatic object identification and user interaction with respect to objects of interest within a signal, is referred to herein as an “interactive signal analyzer.” The interactive signal analyzer monitors one or more signals, identifies objects of interest within such signals, stores statistical and metadata information describing such objects to an object database, and provides an interactive user interface to the object database for providing responses to user queries regarding objects or signals characterized in the object database. As described below, the interactive signal analyzer provides a number of advantages that makes it well suited for providing an interactive object database for viewing and interacting with information extracted from one or more signals. For example, in addition to providing a useful technique for gathering statistical information regarding objects within a signal such as, for example, an audio media stream, automatic identification of objects within the media stream allows a user to interact with that statistical information either in real-time, or subsequent to signal transmission.

In the context of this description, a “signal” is defined to be any time, space, or frequency domain signal of one or more dimensions. Thus, the term “signal,” as used throughout the following paragraphs, will be understood to mean a signal of any type or dimensionality (audio, video, etc.) except where particular signal types are explicitly referred to. For example, such signals include an audio signal which is considered to be a one-dimensional signal; an image is which considered to be a two-dimensional signal; and video data which is considered to be a three-dimensional signal. Further, in the context of a combined audio/video signal, audio objects can be used to identify an associated video sequence, since the audio portion of a combined audio/video signal will typically remain approximately the same between repeating instances of the signal.

Additionally, in the context of this description, “objects of interest” will be understood to include any particular component of any type of input signal that may be of interest. For example, in the context of an audio signal, such objects include, songs, jingles, advertisements, station identifiers, program “signature tunes”, emergency broadcast signals, speech from one or more known speakers, etc.

In general, the interactive signal analyzer provides a framework for sampling one or more signals, such as, for example, one or more channels across the entire FM radio spectrum in one or more geographic regions, to identify objects of interest within the signal, and associate attributes with the identified objects. The interactive signal analyzer uses a signal fingerprint extraction algorithm, i.e., a “fingerprint engine,” for deriving traces from segments of one or more signals. These traces are often referred to as “fingerprints” since they are used to uniquely identify the signal segments from which they are derived. However, in the context of the following discussion, the term “traces” should be understood to mean “trace fingerprints” that are generated several times per second on an incoming signal for comparison to “fingerprints” that are stored in a fingerprint database of known objects of interest. Typically the traces are computed at a higher rate than are fingerprints of objects stored in the fingerprint database. These trace fingerprints are then used for comparison to a database of fingerprints of known objects of interest. Information describing the identified content and associated object attributes is then extracted from the fingerprint database and stored with statistical information to a database of identified objects, e.g. an “object database.” An interactive user interface is then provided for viewing and interacting with information provided in the object database.

It should be noted that the interactive signal analyzer is capable of using any of a number of conventional fingerprint engines, so long as the fingerprint engine is capable of analyzing a signal and generating a relatively unique trace fingerprint that can be compared to a database of preexisting fingerprints. However, several embodiments described below make use of real-time fingerprinting for signal analysis. One example of a real-time fingerprint engine used in extracting fingerprints from an audio signal is described below. However, it should be appreciated by those skilled in the art that the interactive signal analyzer is not intended to be limited to use of the fingerprint engine described below, nor is the interactive database intended to be limited to an analysis of FM radio stations as described in several of the following examples.

The interactive signal analyzer operates by using the fingerprint engine to sample one or more signals for generating a trace fingerprint from each sample. These fingerprints are then compared to a preexisting fingerprint database for identifying signal content from which the samples were extracted. Typically, the fingerprints in the fingerprint database have been derived from the same fingerprint engine that is used to generate trace fingerprints from the sampled signals. In one embodiment, this comparison and identification is accomplished in real time so as to allow for real-time analysis and interaction with the signal content.

In another embodiment, where trace fingerprints generated from samples do not match any fingerprints in the database, those trace fingerprints are added as fingerprints to the fingerprint database as “unknown objects.” This, together with a system which can identify the boundaries of the object in the stream, can be used to identify the occurrence of previously unseen objects. One method for computing the boundaries of a previously unseen object is to use the fingerprint generation process to generate trace fingerprints at repeated, short intervals, so that the repetition of a previously unseen object can be detected, and then, using the knowledge that two copies of the object exist at those two points in the stream, to use other methods to identify the likely boundaries of the object.

For example, in an audio signal, a previously unseen object may occur when new songs, advertisements or other unknown repeating objects appear in the signal. In another embodiment new fingerprint entries derived from the signal are automatically added to the fingerprint database at regular intervals. Consequently, when a new object appears in the signal, it will be recognized the second and subsequent times it appears. Therefore, such objects can still be used in calculating statistics for the signal, even though the objects are unknown. Further, in a related embodiment, users are presented with the opportunity to manually identify such unknown objects via the interactive user interface by entering metadata describing such unknown objects. Alternately such metadata can be added by automatically querying a more authoritative and up-to-date fingerprint database.

An example of a practical application of this embodiment involves automatically generating statistics on content that is likely to be commercials. For example, since most commercials on FM radio are about 15 or 30 seconds long, a database can be compiled of all repeating audio clips that are about 15 or about 30 seconds long, and that were played on the airwaves over a given period of time. Metadata describing those commercials may then be added manually via the user interface, or by importing a more detailed fingerprint engine from another source. Further, since each repeat instance of a given object will be identified in the audio stream, metadata would only need to be added for one instance of each such object. Such information could be used, for example, to construct a service identifying the statistical properties of the times, frequencies and durations of commercials played by competing radio stations.

One fingerprint engine that has been used in a tested embodiment of the interactive signal analyzer uses a “Distortion Discriminant Analysis” (DDA) of a set of training signals to define parameters of a signal feature extractor. This DDA-based fingerprint engine is capable of extracting fingerprints from virtually any type of signal. However, for purposes of explanation, it will be described below in the context of extracting fingerprints from an audio signal.

For example, in one embodiment, the DDA-based fingerprint engine is used for identifying audio segments in an audio stream, such as a radio broadcast. Because the DDA-based fingerprint engine is robust to noise, it is capable of making such identifications even where the audio stream may have been corrupted by noise or other distortions. In operation, this DDA-based fingerprint engine first converts fixed-length segments of an incoming audio stream into low-dimensional traces or “fingerprints.” Each trace fingerprint is then compared against a large set of stored, pre-computed fingerprints, where each stored fingerprint has previously been extracted from a particular audio segment, such as, for example, known songs, jingles, advertisements, station identifiers, program “signature tunes”, emergency broadcast signals, speech from one or more known speakers, etc.

In general, DDA features (fingerprints) are computed by a linear, convolutional neural network, where each layer performs a version of oriented Principal Components Analysis (OPCA) dimensional reduction. Further, the DDA-based fingerprint engine is robust to distortions that are not present in a training set used to initialize the DDA-based fingerprint engine, thereby giving increased reliability of object identification, especially in a relatively noisy environment such as a radio broadcast.

The trace fingerprints are computed at repeated intervals in the stream and are compared with the fingerprint database to locate matches. However, it should be noted that, there are two levels of repetition that are considered here. Specifically, the repeated intervals used for trace fingerprint lookup against a database of fingerprints is typically done several times each second. On the other hand, the actual generation of new fingerprints for addition to the database need not be done more than once every several seconds for detecting otherwise previously unidentified repeats within the signal. In one embodiment, a trace fingerprint that is found in the fingerprint database is then confirmed, at negligible additional computational cost, by using a secondary trace fingerprint generated from the input audio stream.

Given a fingerprint engine such as the DDA-based fingerprint engine described above, identification of objects in one or more input signals serves as the basis for the aforementioned interactive object database. The following discussion provides an example of an interactive signal analyzer system that uses a DDA-based fingerprint engine to analyze the content across a broadcast FM radio spectrum. Note that the system described is equally applicable to any broadcast audio signal, including, for example, satellite radio, Internet or other network audio broadcasts, or an audio signal in a combined audio/video broadcast such as a television signal. Further, the interactive signal analyzer is not restricted to music or songs in fingerprinting and identifying the audio stream or streams of one or more radio stations. For example, a given commercial could be fingerprinted, or a given segment of speech. In addition, it should be clear that monitored audio streams are not limited to radio frequency broadcasts, and in fact, include any television broadcast, any Internet or network broadcast, or any other type of audio broadcast, either digital or analog.

In a tested embodiment, the interactive signal analyzer provides an interactive object database which provides an analysis of content broadcast via an FM radio frequency spectrum in response to user queries. This system is implemented by using one or more computers, each computer having one or more tuners/receivers to monitor at least one FM radio station. In a related embodiment, multiple computers and tuners are used to monitor some or all FM stations receivable within one or more geographic regions. Clearly, this embodiment is extensible to the case where all FM radio broadcasts are monitored in all geographic regions. In another related embodiment, rather than dedicate a particular computer/tuner combination to a particular channel, one or more of the computer/tuner combinations are designed to automatically switch frequencies and monitor two or more particular frequencies for predetermined periods at predetermined intervals.

Further, N radio stations can be monitored using only M PCs, where N>M, as follows. First, special purpose hardware with several tuners can be used to generate streams which are fed (for example, as packet data over a network) to several individual copies of the fingerprint engine running on one PC, each of which monitors one stream. Second, once a given fingerprint engine has identified a given object, if the duration of that object is known, and if the location of the fingerprint in that object is known, then that particular fingerprint engine can ‘switch off’ temporarily, for the remaining duration of the object, to save computational resources. In this way, the number of PCs needed to cover a given geographical region can be reduced.

Whichever of the radio monitoring embodiments described above are used, the basic premise is that an audio stream is captured and made available for analysis on one or more computers. The incoming audio stream or streams are then provided to one or more instances of the fingerprint engine which then produces trace fingerprints from sampled sections of the audio stream. The fingerprint engine then determines the name and other metadata (artist, length, music genre or subgenre, etc.) of any song, or other identified repeating object that occurs in the audio stream through a comparison to matching entries in the fingerprint database. Further, in one embodiment, a user interface is used to provide one or more audio clips or samples, such as a particular song, commercial, speaker, etc. to the fingerprint engine for fingerprinting. Such user provided content, along with any user supplied metadata, is automatically included in the fingerprint database. Note that the term “fingerprint database” is used interchangeably with the term “metadata database” in the following discussion, as the fingerprint database includes metadata describing each object represented by a fingerprint.

The computation of fingerprints and comparison to the object database occurs in near real-time. Consequently, there is no need to buffer or store the captured audio stream once its objects have been identified. However, in one embodiment, the incoming audio stream is either buffered for a desired period of time (minutes, hours, days, etc.), or simply recorded to a conventional computer storage device. Buffering or recording the captured audio stream provides the user with the capability to interact with the audio stream after its individual objects have been identified. For example, the user may want to replay a most popular song in terms of total radio plays on one or more radio stations. Recording the audio stream in addition to identifying the objects within that stream will allow the user to both identify the most popular song and immediately jump to a position within the recorded stream where that song was identified.

In operation, the fingerprint engine includes a metadata database, Dₘ, of objects for which fingerprints have been pre-computed, and in which fingerprints and metadata (e.g., for songs, the name of the song, artist, album title, copyright year, music genre or subgenre, etc.; and for commercials, the advertisement title, name of the advertised product; etc.) is available. Each incoming audio stream is monitored by the fingerprint engine which produces trace fingerprints from sections of the audio stream. These trace fingerprints are then compared to the pre-computed fingerprints in the metadata database to locate matches. Note that the recognition accuracy can be increased by using two or more fingerprints per audio clip.

In one embodiment, when a match is identified, the metadata from the metadata database is associated with the portion of the stream then playing, via an object database, since it can be inferred that the object identified in the database is playing at that point in the stream. In one embodiment, this data is provided to a user in real-time as the stream is playing. Once an object has been identified in the audio stream, the information describing that object, along with statistical information such as time and date played, and the particular radio station on which it was played is stored to an object or “station” database, Dₛ. However, if an object is detected more than once on the same station, it is better to simply increment a counter for that object rather than creating a new entry for the already played object. Further, the existing entry for that object in the Dₛ database can be expanded to include the time and date of each new occurrence, and other statistical information that may be of interest. Consequently, over time, the station database, Dₛ, will be populated with more and more information about the content that each monitored station plays. Note that the term “object database” is used interchangeably with the term “station database” in the following discussion, as the object database includes object identification and metadata describing each object identified in the audio streams on a station-by-station basis.

In a tested embodiment of the interactive signal analyzer, it was observed that some stations play a limited collection of songs that are repeated fairly often, while others play larger collections. Therefore, such stations will appear in the station database Dₛ with one or more entries, depending upon the number of objects played and identified. However, stations that are observed to play little or no music at all and consist mostly of talk programs that seldom repeat are significantly less likely to appear in the station database, Dₛ, except with respect to repeating objects such as commercials. However, in a related embodiment, particular objects, such as commercials, for example, can be excluded from inclusion in the station database. This embodiment is particularly useful where the user is only interested in a particular type of content, such as songs, rather than all objects that might be identifiable in the audio stream.

The process summarized above is repeated on as many radio stations as desired in a given geographical reception area. In one embodiment, this process is implemented in parallel using different receivers to monitor all of the stations simultaneously. However, this embodiment requires the use of as many receivers and fingerprint engines as stations being monitored, though it would still require only one metadata database Dₘ and one station database Dₛ. After sufficient time has passed, typically on the order of about a few days, a fairly accurate representation of the type of content each monitored station plays will be available in the station database Dₛ. For example, if a station plays mostly music hits from the 1980's, the entries in Dₛ for this station will reflect this. Further it is possible, by querying Dₛ, to gather any desired statistics, such as, for example, “Top 10” lists, songs by artist, artists played, frequency of songs, frequency of artist, times that particular songs or artists were played, etc., for each station.

In addition, in another embodiment, cross station queries are implemented. In other words, it is possible to compare two or more stations by querying Dₛ. For example, questions such as “Which station plays the most <Pink Floyd>?” are readily posed by storing the data in a conventional SQL-type database, such as, for example, the Microsoft© SQL Server 2000™. Using such a database, any of a number of desired database queries that may be of interest to users can easily be answered using standard SQL query language.

As noted above, in one embodiment, users are presented with a user interface for implementing queries in SQL (or any other database query language) against the station database, Dₛ. However, in another embodiment, rather than allowing clients to query the database Dₛ directly, an interactive graphical user interface (GUI), such as, for example, an HTML or Web-type interface having a set of predefined user accessible SQL queries is provided. This interactive GUI contains a number of structured queries that allows the user to input certain variables using conventional controls such as, for example, text input windows, dropdown lists, check boxes, radio buttons, etc. For example, referring back to the example query “Which station plays the most <Pink Floyd>?,” this question can be pre-written, while the variable <Pink Floyd> is input or selected via the user interface. Clearly, a large variety or type of queries that may be of interest to a user, may be posed in a structured form via the user interface, and translated into an SQL query for presentation to the station database Dₛ.

In the embodiments described above, the examples illustrate scenarios where the user is requesting, or pulling, data from the server, either via direct database queries or through the GUI. However, in a related embodiment, rather than the user requesting particular information or data, that information is instead automatically sent, or pushed, to the user. For example, in one such embodiment users are provided with information regarding one or more streams by subscribing to a service that pushes data to them. By way of example, such information may include any of the information described above, such as a weekly snapshot of what a particular radio station played. This information is then automatically transmitted to the user's computer. In one embodiment, this automatic transmission takes the form of an automatically generated report that is simply sent to a predefined user e-mail address.

In addition to the just described benefits, other advantages of the system and method for automatically identifying and storing content information for sampled signals, and providing a user interface for allowing interactive user queries and display of the stored content information will become apparent from the detailed description which follows hereinafter when taken in conjunction with the accompanying drawing figures.

### DESCRIPTION OF THE DRAWINGS

The specific features, aspects, and advantages of the “interactive signal analyzer” will become better understood with regard to the following description, appended claims, and accompanying drawings where:

FIG. 1 is a general system diagram depicting a general-purpose computing device constituting an exemplary system for automatically identifying and storing content information for sampled signals, and providing a user interface for allowing interactive user queries and display of the stored content information.

FIG. 2 illustrates an exemplary architectural diagram showing exemplary program modules for automatically identifying and storing content information for sampled signals, and providing a user interface for allowing interactive user queries and display of the stored content information.

FIG. 3 illustrates an exemplary architectural diagram showing exemplary program modules for training a feature extractor for extracting fingerprints from signals.

FIG. 4 illustrates an exemplary architectural diagram showing exemplary program modules for using the feature extractor of FIG. 3 for identification of objects in signals, including creation of a “fingerprint database” and comparison of trace fingerprints extracted from the signals to fingerprints in the fingerprint database.

FIG. 5 illustrates an exemplary system flow diagram for automatically identifying and storing content information for sampled signals, and providing a user interface for allowing interactive user queries and display of the stored content information.

FIG. 6 illustrates system flow diagram of a tested embodiment for monitoring one or more audio broadcasts for automatically identifying and storing content information for sampled audio channels, and providing a web-based HTML-type user interface for allowing interactive user queries and display of the stored content information.

FIG. 7 illustrates an exemplary HTML-type web interface having predefined queries for interaction with a database of identified objects created by monitoring a number of FM radio stations in a particular geographic area.

FIG. 8 illustrates an exemplary interactive display of statistical information gathered for a particular radio station, with this interactive display being accessible via the HTML-type web interface of FIG. 6.

FIG. 9 illustrates an exemplary interactive display of music artists played by multiple stations, with this interactive display being accessible via the HTML-type web interface of FIG. 6.

FIG. 10 illustrates an exemplary interactive display of the top N identified songs played on a user selected radio station, with this interactive display being accessible via the HTML-type web interface of FIG. 6.

### DETAILED DESCRIPTION OF THE PREFERRED EMBODIMENTS

In the following description of the preferred embodiments of the present invention, reference is made to the accompanying drawings, which form a part hereof, and in which is shown by way of illustration specific embodiments in which the invention may be practiced. It is understood that other embodiments may be utilized and structural changes may be made without departing from the scope of the present invention.

1.0 Exemplary Operating Environment:

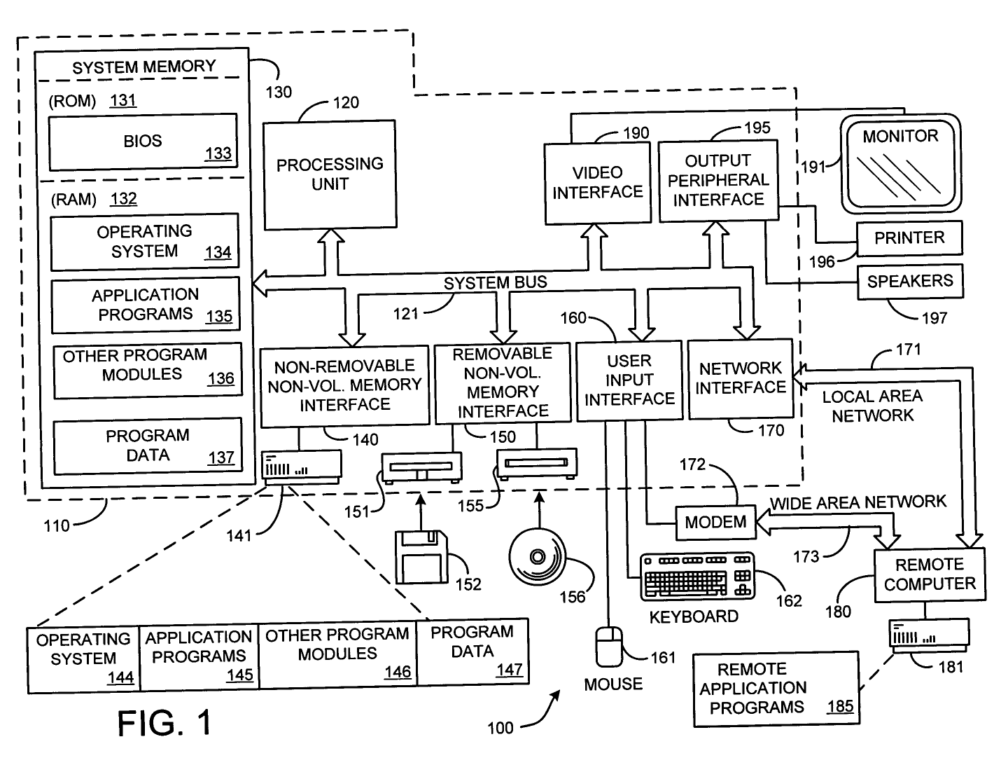

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held, laptop or mobile computer or communications devices such as cell phones and PDA's, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices. With reference to FIG. 1, an exemplary system for implementing the invention includes a general-purpose computing device in the form of a computer 110.

Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile removable and non-removable media implemented in any method or technology for storage of information such as computer readable instructions, data structures, program modules, or other data.

Computer storage media includes, but is not limited to, RAM, ROM, EEPROM, flash memory, or other memory technology; CD-ROM, digital versatile disks (DVD), or other optical disk storage; magnetic cassettes, magnetic tape, magnetic disk storage, or other magnetic storage devices; or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball, or touch pad.

Other input devices (not shown) may include a microphone, joystick, game pad, satellite dish, scanner, radio receiver, and a television or broadcast video receiver, or the like. These and other input devices are often connected to the processing unit 120 through a user input interface 160 that is coupled to the system bus 121, but may be connected by other interface and bus structures, such as, for example, a parallel port, game port, or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device, or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets, and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

The exemplary operating environment having now been discussed, the remaining part of this description will be devoted to a discussion of the program modules and processes embodying a system and method for automatically identifying and storing content information for sampled signals, and providing a user interface for allowing interactive user queries and display of the stored content information.

2.0 Introduction:

An “interactive signal analyzer,” as described herein, provides a reliable and straightforward method for automatically identifying and storing content information for sampled signals, and providing a user interface for allowing interactive user queries and display of the stored content information. In general, the interactive signal analyzer uses a signal fingerprint extraction algorithm, i.e., a “fingerprint engine,” for deriving traces from segments of one or more signals. These traces are often referred to as “fingerprints” since they are used to uniquely identify the signal segments from which they are derived. However, in the context of the following discussion, the term “traces” should be understood to mean “trace fingerprints” that are generated several times per second on an incoming signal for comparison to “fingerprints” that are stored in a fingerprint database of known objects of interest. Typically the traces are computed at a higher rate than are fingerprints of objects stored in the fingerprint database. These trace fingerprints are then used for comparison to a database of fingerprints of known objects of interest. Information describing the identified content and associated object attributes is then provided in an interactive user database for viewing and interacting with information resulting from the comparison of the trace fingerprints to the database.

In the context of this description, a “signal” is defined to be any time, space, or frequency domain signal of one or more dimensions. Thus, the term “signal,” as used throughout the following paragraphs, will be understood to mean a signal of any type or dimensionality (audio, video, etc.) except where particular signal types are explicitly referred to. For example, such signals include an audio signal which is considered to be a one-dimensional signal; an image is which considered to be a two-dimensional signal; and video data which is considered to be a three-dimensional signal. Further, in the context of a combined audio/video signal, audio objects can be used to identify an associated video, since the audio portion of a combined audio/video signal will typically remain approximately the same between repeating instances of the signal.

Additionally, in the context of this description, “objects of interest” will be understood to include any particular component of any type of input signal that may be of interest. For example, in the context of an audio signal, such objects include, songs, jingles, advertisements, station identifiers, program “signature tunes”, emergency broadcast signals, speech from one or more known speakers, etc. Clearly, other signal types may include other identifiable objects of interest for which automatic identification would be desired.

2.1 System Overview:

In general, the interactive signal analyzer provides a framework for sampling one or more signals, such as, for example, one or more channels across the entire FM radio spectrum in one or more geographic regions, to identify objects of interest within the signal content and associate attributes with that content. The interactive signal analyzer uses a signal fingerprint extraction algorithm, i.e., a “fingerprint engine,” for deriving traces from segments of one or more signals. These traces are referred to as “trace fingerprints” since they are used to uniquely identify the signal segments from which they are derived. These trace fingerprints are then used for comparison to a database of fingerprints of known objects of interest.

Information or “metadata” describing the identified content and associated object attributes is then provided in an interactive user database for viewing and interacting with information resulting from the comparison of the trace fingerprints to the database. Metadata can include any identifying information that it the user desires to have associated with particular objects or object types. For example, for songs, metadata may include the name of the song, artist, album title, copyright year, music genre or subgenre, etc. Similarly, for commercials, metadata may include the advertisement title, name of the advertised product, etc. Clearly any type of metadata that is appropriate to a particular signal type and object can be included in the metadata for particular objects.

It should be noted that the interactive signal analyzer is capable of using any of a number of conventional fingerprint engines, so long as the fingerprint engine is capable of analyzing a signal and generating a relatively unique fingerprint that can be compared to a database of preexisting fingerprints. However, several embodiments described below make use of real-time fingerprinting for signal analysis. One example of a real-time fingerprint engine used in extracting trace fingerprints from an audio signal is described below in Section 3.1.1. However, it should be appreciated by those skilled in the art that the interactive signal analyzer is not intended to be limited to use of the fingerprint engine described below, nor is the interactive database intended to be limited to an analysis of FM radio stations as described in the following example.

In operation, the fingerprint engine samples one or more signals and generates a trace fingerprint from each sample. These trace fingerprints are then compared to a preexisting fingerprint database of known objects for identifying signal content from which the samples were extracted. In one embodiment, this comparison and identification is accomplished in real time so as to allow for real-time analysis and interaction with the signal content. Information relating to the identified signal content is then stored to one or more object databases that include the identification and other characteristic information collected for each object identified in the signal. Finally, an interactive user interface for accessing either predefined or user defined queries of the object database is provided.

In another embodiment, where trace fingerprints generated from samples do not match any fingerprints in the fingerprint database, those trace fingerprints are added to the fingerprint database as fingerprints representing “unknown objects.” This may occur, for example, when new songs, advertisements or other unknown repeating objects appear in the signal. In another embodiment new fingerprint entries derived from the signal are automatically added to the fingerprint database at regular intervals. Consequently, when a new object appears in the signal, it will be recognized the second and subsequent times it appears. Therefore, such objects can still be used in calculating statistics for the signal, even though the objects are unknown. Further, in a related embodiment, users are presented with the opportunity to manually identify such unknown objects via the interactive user interface by entering metadata describing such unknown objects. Alternately such metadata can be added by automatically querying a more authoritative and up-to-date fingerprint database.

An example of a practical application of the previous embodiment involves automatically generating statistics on content that is likely to be commercials. For example, since most commercials on FM radio are about 15 or 30 seconds long, a database can be compiled of all repeating audio clips that are about 15 or about 30 seconds long, and that were played on the airwaves over a given period of time. Metadata describing those commercials may then be added manually. Further, since each repeat instance of a given object will be identified in the audio stream, metadata would only need to be added for one instance of each such object. On the other hand, if the user is not interested in the actual identity of particular objects, such as particular commercial, but is interested in statistical information of commercials as a group, then there is no need to add metadata describing such objects, as the statistical information will be computed or gathered automatically. In one embodiment, such information is then used, for example, by a radio station to assess the marketing strategies of its competitors.

2.2 System Architecture:

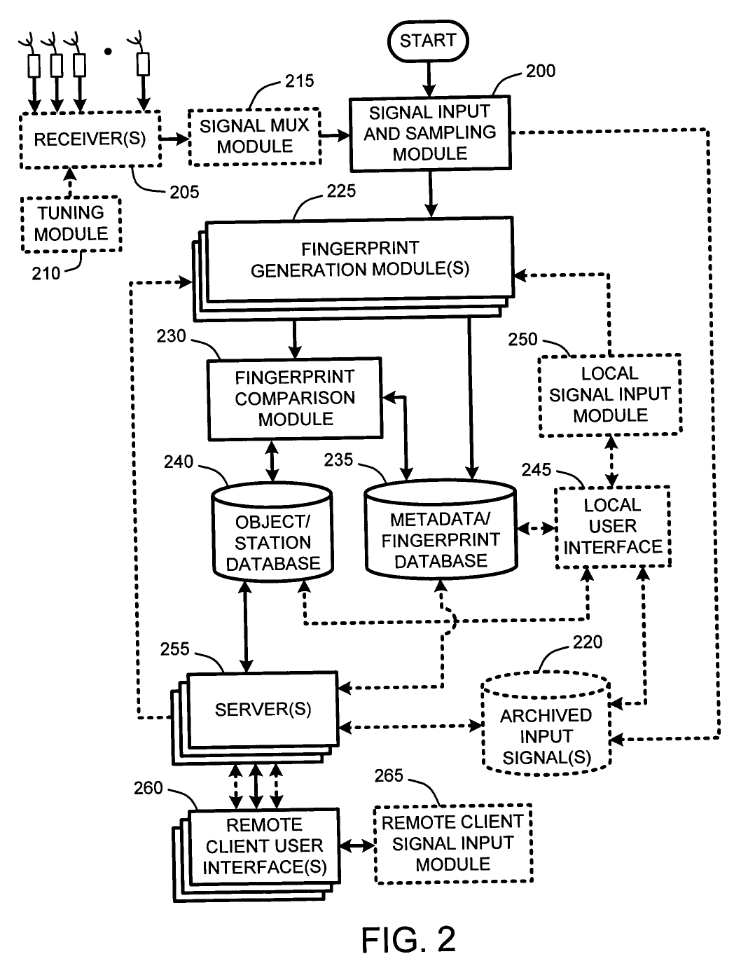

The processes summarized above are illustrated by the general system diagram of FIG. 2. In particular, the system diagram of FIG. 2 illustrates the interrelationships between program modules for implementing the interactive signal analyzer. It should be noted that the boxes and interconnections between boxes that are represented by broken or dashed lines in FIG. 2 represent alternate embodiments of interactive signal analyzer described herein, and that any or all of these alternate embodiments, as described below, may be used in combination with other alternate embodiments that are described throughout this document.

In particular, as illustrated by FIG. 2, a system and method for automatically identifying and storing content information for sampled signals, and providing a user interface for allowing interactive user queries and display of the stored content information begins by using a signal input and sampling module 200 to receive and sample one or more signals, such as, for example, audio broadcast signals, video broadcast signals, etc. Note that sampling frequency of the input signal is discussed in more detail in section 3.1.1. In one embodiment, radio or television broadcasts are captured using one or more receivers 205. Tuning of the receivers 205 is accomplished either manually or automatically using a conventional tuning module 210 for tuning one or more of the receivers to particular channels or stations.

In additional embodiments, a tunable receiver is used to automatically switch between two or more channels, with the channels then being multiplexed into a single stream for analysis. In one such embodiment, a tunable receiver of the interactive signal analyzer switches between stations at fixed times without being concerned about missed or dropped identifications as a result of objects occurring in a particular stream while that stream was not being monitored. Over time, this embodiment will still produce a fairly reliable statistical picture of such streams. A related embodiment uses a tunable receiver to automatically switch from one stream to another at times determined in part by what has just been identified in a monitored stream. For example, in this embodiment, once an object has been identified, there is no need to monitor that stream for at least the remaining duration of the object that has just been identified. These embodiments are described in further detail below.

In one embodiment the stream from one or more received channels is not sampled continuously. For example, the stream might be sampled for a time great enough to calculate a trace fingerprint, but then not sampled at all for some time. This has the advantage of permitting a machine with a single receiver and/or soundcard to handle more than one received channel. Of course, if a stream is sampled in this way there is a possibility that objects in the stream will not be detected by the fingerprint scheme. However, for applications where the statistical makeup of the stream is of greater concern than a precise decomposition of what it contains, this may be adequate. For example, if one fingerprint is calculated per minute for a repetitive FM radio station, the interactive signal analyzer will miss many of the songs that play, but over time, an accurate statistical picture of the contents of the stream will still emerge.

In a related embodiment, if a single computer is listening to several channels by multiplexing between them, the frequency with which it samples a given channel is inversely proportional to the repetitiveness of the channel. To use a very simple example, if a computer were listening to three channels, which played respectively 100, 200 and 1000 songs and no other repeating objects, it would make sense to devote most listening time to the channel that plays 1000 songs, and least to the one that plays only 100 songs.

In a related embodiment, the switching between stations can be driven, in part, by what is identified. For example, if a song has been identified in real time, since the location of the trace fingerprint is known, then it is safe to switch away from that station for the remainder of the song. In this embodiment it is advantageous to choose fingerprints from close to the beginning of the audio clip, to provide longer intervals for which it is known what is being played.

In another embodiment, when listening to a particular channel, the fingerprints of previously identified objects from that channel are searched first in the database, thereby speeding the search. For example, when listening to a station that plays pop hits from the 1980's repetitively it makes sense to search the fingerprints of songs previously identified on that station, before searching the larger database. If the currently playing object is indeed a repeat of a previously seen object the search terminates early, while otherwise the main database is searched.

In yet another one embodiment a user is given the ability to request the portions of a stream surrounding a particular object. For example, an advertiser might wish to see the context in which his/her commercial plays.

In one embodiment where the frequency and timing with which unidentified objects are played is logged by entering fingerprints in the database, and then noting the second and subsequent instances, the database is pruned periodically to prevent its becoming too large. For example, fingerprints that have been entered, but have never been matched are deleted after a suitable length of time. When listening to a talk radio show, for example, it would make little sense to allow the fingerprints of audio segments that are never likely to repeat to populate the database and slow the searches.

Note that in one embodiment, each input signal is buffered or stored to an archived input signal database 220. Further, to reduce storage requirements, any conventional compression techniques, either lossy or lossless, as desired, may be used for compressing the input signals prior to storage in the archived input signal database 220. As described in further detail below, storing the input signals in the archived input signal database 220 allows a user to play back one or more portions of an input signal, or even jump to a point in an archived signal corresponding to an identified object of interest.

Once the signal input and sampling module 200 begins to receive one or more signals, or one or more multiplexed signals, signal samples are continuously provided in real-time to one or more fingerprint generation modules 225 for extracting fingerprints from samples of the input signals (see Section 3.1.1). While a single fingerprint generation module 225 can be used to extract fingerprints from multiple signals, only one signal, or multiplexed signal, at a time can be processed by an individual fingerprint extraction module. In other words, fingerprint extraction algorithms typically operate on only one input signal at a time for extracting fingerprints. Consequently, a separate instance of the fingerprint extraction module 225 is provided for each input signal, or multiplexed signal. Therefore, each instance of the fingerprint extraction module 225 is either run on a separate computer system, or on one or more computer systems having sufficient multi-processing capability for running multiple instances of the fingerprint extraction module in parallel.

Note that for purposes of clarity, the remainder of the discussion of FIG. 2 will refer to a single fingerprint extraction module 225 and a single input signal. However, it should be clear that the following discussion is equally applicable to multiple instances of the fingerprint extraction module 225 acting in parallel on multiple input signals.

Once the fingerprint extraction module 225 has extracted a fingerprint from the sampled input signal, that fingerprint is provided to a fingerprint comparison module 230. The fingerprint comparison module 230 then searches a metadata/fingerprint database 235 having pre-computed fingerprints and metadata describing objects represented by the pre-computed fingerprints. If a match is identified by the fingerprint comparison module 230, then the sampled portion of the input signal from which the fingerprint was extracted is identified as belonging to an object of interest corresponding to the fingerprint and metadata in the metadata/fingerprint database 235. This information, including the metadata, is stored in an object/station database 240. Therefore, for each identified object of interest, the object/station database includes statistical information such as the time that the object was identified, the station, channel, frequency, etc., where the input signal was monitored, and any metadata stored in the metadata/fingerprint database 235 for that particular object.

Note that it is quite common for a second or subsequent instance of a particular object of interest to be identified in the input signal. For example, it is quite common for a particular song to be played on one or more radio stations throughout the day. Therefore, multiple instances of that song will be identified on monitored radio stations. Therefore, rather than creating a new entry in the object/station database 240, a counter representing a total number of identifications for that object of interest is simply incremented in the existing entry for that object, along with the statistical information documenting the time that the object was identified, and the station, channel, frequency, etc. where the input signal was monitored. Unless the metadata for that object has been changed since the first instance of an object was identified, the metadata entry in the object/station database will not be changed upon the identification of a second or subsequent instance of a particular object.

In a related embodiment, if the fingerprint extracted from the sampled input signal does not match any entries in the metadata/fingerprint database 235, that fingerprint is stored to the metadata/fingerprint database as an “unknown object” entry, along with either a copy of the sample, or a pointer to a location in the input signal where the sample was taken. Further, any statistical information available for the sample, such as, for example, the broadcast date and time of the sample, and the station, channel, frequency, etc. where the input signal was monitored. If any subsequent occurrences of an object having a matching fingerprint are identified, then both the first instance of the unknown object, and each subsequent instance, will then be added to the object/station database 240 along with any statistical information that is available for that object.

Further, in another related embodiment, the metadata/fingerprint database 235 is open to user browsing and editing, so that unknown objects can be manually identified by a user via a local user interface 245, or alternately, via a remote client user interface 260. In addition, whenever any metadata in the metadata/fingerprint database 235 is edited or modified, any corresponding entry in the object/station database 240 is automatically updated to reflect the changes in the metadata. In the fashion, the two databases are kept synchronized with respect to metadata content.

The local user interface 245 provides a user interface, such as a command line interface, a graphical user interface (GUI), or a web browser-based user interface for interacting with either or both the metadata/fingerprint database 235, and the object/station database 240. Typically, unless the user wants to browse entries in the metadata/fingerprint database 235, or edit metadata in that database, the user will be interfacing with the object/station database 240. As noted above, the object/station database 240 provides statistical information and metadata for all objects identified in the input signal.

In one embodiment, the object/station database 240 is implemented using a SQL-type database such that the user can input conventional SQL queries against the object/station database via one of the aforementioned local user interfaces 245. This allows the user to view, display, or interact with the data compiled in the object/station database 240, as desired. Further, in one embodiment, a local signal input module 250 is provided to allow the user to manually enter one or more samples. Metadata describing such user entered samples may also be entered into the metadata/fingerprint database 235. As soon as the user enters a sample via the local signal input module, that sample is provided to the fingerprint generation module 225, and the generated fingerprint is then immediately stored to the metadata/fingerprint database 235, along with any metadata entered by the user. Consequently, any samples from the input signal provided via the signal input and sampling module 200 that have fingerprints matching that of the user entered sample will be added to the object/station database 240 as an identified object of interest.

For example, when monitoring audio streams, if the user desires to identify occurrences of a particular phrase spoken by the President, such as, for example “axis of evil,” then the user would simply provide an audio clip of that recording of that phrase to the fingerprint generation module 225 via the local signal input module 250. Subsequent to that user entry, any time that same recording of the phrase “axis of evil” is spoken by the President on any monitored audio signal, that phrase will be identified, and statistical information and metadata regarding the identified phrase will be automatically added to the object/station database 240 as described above. Note that the aforementioned recognition of particular spoken phrases involves identification of a repeat copy of the same spoken phrase, not a new copy of the spoken phrase. In other words, the interactive signal analyzer is matching identical objects that may differ only by noise or other signal artifacts rather than performing speech recognition. Consequently, the same phrase spoken by the same person on two different occasions will likely require unique fingerprints for each instance, depending upon the similarity of the two instances of the phrase.

It should be appreciated that user entry of signal samples is not to be limited to audio clips, and that in fact, the user can enter any type of signal sample that is being monitored by the fingerprint generation module 225, such as, for example, audio signals, video signals, acceleration data signals, electrocardiogram signals, etc.

In a related embodiment, rather than allowing the user to input conventional SQL queries against the database, predefined queries are presented to the user as user selectable or adjustable options via the local or remote GUI or web-browser based user interface. For example, rather than requiring the user to understand database query language, a predefined database query string can be associated with a user selectable button, check box, radio button, dropdown menu, etc. For example, assuming the monitoring of one or more radio stations, the user may be presented with a dropdown menu listing call signs of each monitored radio station. User selection of a particular radio call sign may then automatically call up a display of statistical information regarding that radio station, and the objects of interest, songs, commercials, etc., identified for that radio station. In this manner, the user can quickly view information describing monitored input streams without needing to type in detailed queries. Examples of such a user interface having predefined queries represented via user selectable options are described in further detail in Section 4.

In an embodiment that is similar to the local user interface 245, the aforementioned remote client user interface 260 is provided for remotely interacting with the object/station database 240 and the metadata/fingerprint database 235, and any archived input signals 220. In general, the remote client user interface 260 operates across a network, such as the Internet, or other local intranet or network via one or more servers 255. Clearly, conventional networking protocols for a network environment such as the Internet, or other local intranet or network, allow any number of remote users to simultaneously access either the object/station database 240 or the metadata/fingerprint database 235.

In any case, the remote client user interface 260 provides the same functionality as described above for the local user interface 245, including a remote client signal input module 265 that allows remote users to provide signal samples to the fingerprint comparison module 225, via the server 255. Again, as described above, any user provided signal sample is used for generating a fingerprint that is added to the metadata/fingerprint database 235 for use in identifying objects of interest in monitored signals.

3.0 Operation Overview:

The above-described program modules are employed in an interactive signal analyzer for automatically identifying and storing content information for sampled signals, and providing a user interface for allowing interactive user queries and display of the stored content information. The following sections provide a detailed operational discussion of exemplary methods for implementing the aforementioned program modules.

3.1 Operational Elements:

As noted above, the interactive signal analyzer described herein monitors one or more input signals, derives trace fingerprints from sampled sections of the input signals, identifies the content represented by those sampled sections, compiles statistical information and metadata describing the identified content to an object database, and provides an interactive user interface for querying the object database. This process is implemented using several basic components, including a fingerprint engine, such as the aforementioned DDA-based fingerprint engine, the fingerprint/metadata database, the object database for objects identified in monitored signals, database queries, and the interactive user interface. Each of these components is described in detail in the following sections in the context of simultaneously monitoring one or more channels of an FM frequency broadcast spectrum.

However, as noted above, the interactive signal analyzer is not restricted to music or songs in fingerprinting and identifying objects in an audio stream or streams. Further, also as noted above, the interactive signal analyzer is not restricted to audio signals such as radio or television broadcasts. Additionally, monitored audio streams are not limited to radio frequency broadcasts, and, in fact, include any television broadcast, any Internet or network broadcast, or any other type of audio broadcast, either digital or analog. For example, in an audio stream, a given commercial can be fingerprinted, or a given piece of speech. Similarly, in a video stream, a given image frame or image sequence can be fingerprinted. Further, in an electrocardiogram signal, a particular heart rhythm can be fingerprinted. Clearly, any type of signal or object of interest may be monitored and processed by the interactive signal analyzer.

3.1.1 DDA-Based Fingerprint Engine:

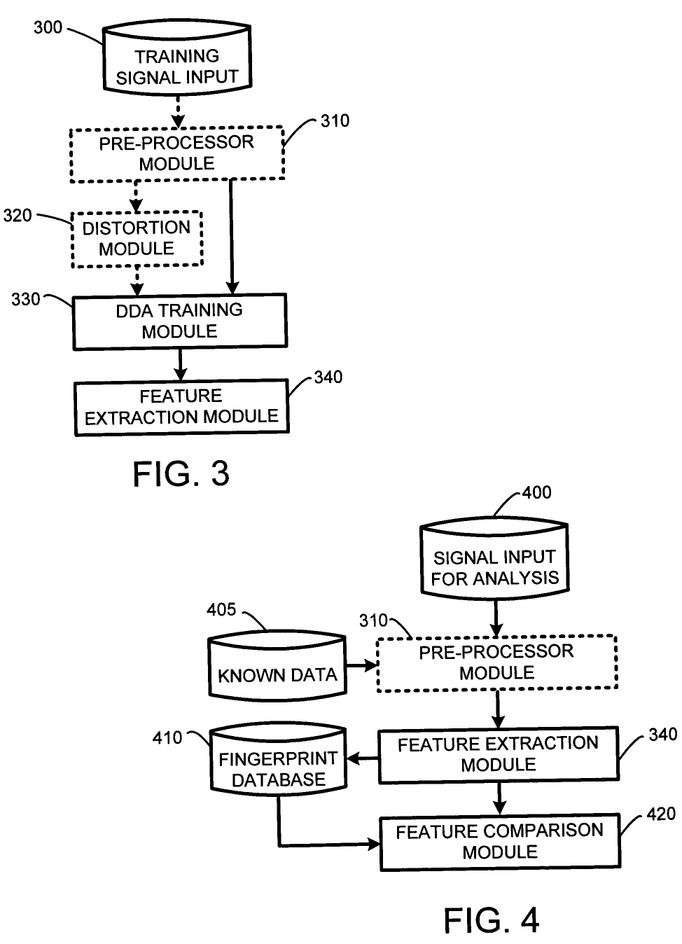

As noted above, the interactive signal analyzer is capable of using any of a number of conventional fingerprint engines, so long as the fingerprint engine is capable of analyzing a signal and generating a relatively unique trace fingerprint that can be compared to a database of preexisting fingerprints. One fingerprint engine that has been used in a tested embodiment of the interactive signal analyzer uses a “Distortion Discriminant Analysis” (DDA) of a set of training signals to define parameters of a signal feature extractor. This DDA-based fingerprint engine is capable of extracting fingerprints from virtually any type of signal. However, for purposes of explanation, it will be described below in the context of training the fingerprint engine, and extracting fingerprints from an audio signal with respect to FIG. 3 and FIG. 4.

Further, it should be noted that this DDA-based fingerprint engine has been previously described in a printed publication entitled “Distortion Discriminant Analysis for Audio Fingerprinting” by Christopher Burges, John Platt, and Soumya Jana. Technical Report MSR-TR-2001-116, Microsoft Corporation, 2001. The subject matter of which is incorporated herein by this reference. However, for purposes of explanation, this DDA-based fingerprint engine will be generally described below.

In general, the DDA-based fingerprint engine automatically extracts noise-robust features, e.g., “fingerprints” from an input signal such as an audio signal. These DDA features are computed by a linear, convolutional neural network, where each layer performs a modified version of oriented Principal Components Analysis (OPCA) dimensional reduction. Further, the DDA-based fingerprint engine is capable of automatically adapting to distortions that are not present in a training set used to initialize the DDA-based fingerprint engine. This property of the DDA-based fingerprint engine serves to increase overall reliability of object identification, especially in a relatively noisy environment such as a radio broadcast. For example, in one embodiment, the DDA-based fingerprint engine is used for identifying audio segments in an audio stream, such as a radio broadcast. Further, because the DDA-based fingerprint engine is robust to noise, it is capable of making such identifications even where the audio stream may have been distorted or otherwise corrupted by noise.

In operation, this DDA-based fingerprint engine first converts a fixed-length segment of an incoming audio stream into a low-dimensional trace or “fingerprint.” This trace fingerprint is then compared against a large set of stored, pre-computed fingerprints, where each stored fingerprint has previously been extracted from a particular audio segment, such as, for example, songs, jingles, advertisements, station identifier, program “signature tunes”, emergency broadcast signals, speech from one or more known speakers, etc.

In particular, as illustrated by FIG. 3, initial training of the DDA-based fingerprint engine begins by providing one or more training signal inputs 300 from a computer file or input device to a pre-processor module 310. Typically, such training signal inputs should be relatively similar to the types of objects that it is desired to identify in a signal. For example, training the DDA-based fingerprint engine to extract fingerprints from audio objects such as songs and commercials is best done using songs and commercials as the training signal input 300.

The pre-processor module 310 removes known distortions or noise from the training signal input 300 by using any of a number of well-known conventional signal processing techniques. For example, given an audio signal, if equalization is a known distortion of the signal, then de-equalization is performed by this embodiment. Similarly, given an image signal, if contrast and brightness variation is a known distortion of the signal, then histogram equalization is performed by this embodiment. Note that in further embodiments, the pre-processor module is used for removing known distortions or noise from both the input signal input 300 and known data 405 (See FIG. 4).

Next, whether or not the training input signal 300 has been pre-processed 310 as described above, the training input signal is provided to a distortion module 320. The distortion module 320 then applies any desired distortion or noise to the training input signal 300 to produce at least one distorted copy of the training signal input. For example, again using an audio signal for purposes of discussion, such distortions include any of low-pass, high-pass, band-pass, and notch filters, companders, noise effects, temporal shifts, phase shifts, compression, reverb, echo, etc. For image signals, such distortions include, for example, any of scaling, rotation, translation, thickening, and shear.

The distorted training signal inputs are then provided to a DDA training module 330. In addition, undistorted copies of the training input signal is provided directly to the DDA training module 330 either directly from the training signal input 300, or via the pre-processor module 310. In an alternative embodiment, distorted signals are captured directly from an input source. For example, again using an audio signal for purposes of discussion, such distorted versions of an audio input are captured directly from an input source, such as a radio broadcast. This alternative embodiment does not require use of the distortion module 320. For example, copies of a particular song or audio clip captured or recorded from several different radio or television broadcasts typically exhibit different distortion and noise characteristics for each copy, even if captured from the same station, but at different times. Thus, the different copies are typically already sufficiently distorted to allow for a distortion discriminant analysis that will produce robust features from the training data, as described in further detail below.

As noted above, the DDA training module 330 receives both distorted and undistorted copies of the training input signal 300. Finally, once the DDA training module 330 has both the undistorted training data and the distorted copies of the training data, it applies DDA to the data to derive multiple layers of oriented Principal Components Analysis (OPCA) projections, which are supplied to a feature extraction module 340 for use in extracting fingerprints from input signals. At this point, with the OPCA projections being supplied to the feature extraction module 340, the fingerprint engine has been fully trained and is ready for use in extracting features (e.g., fingerprints) from one or more input signals. It should be noted that this training step does not need to be repeated once the system has been trained. For example, because this fingerprint engine is used in generating the fingerprints for the fingerprint database of known objects, it will have already been trained by the time that signal monitoring for detection of known objects begins.

Next, as illustrated by FIG. 4, once trained, the fingerprint engine derives fingerprints from known data 405, e.g., known songs, commercials, station jingles, etc., by applying the multiple layers of OPCA projections derived during training of the fingerprint engine to one or more sets of known data to produce sets of known features using the trained feature extraction module 340. For example, with respect to an audio signal comprised of songs, the known data 405 would represent one or more known songs that when passed through the DDA trained feature extraction module 340 will produce features (i.e., fingerprints) which then correspond to the known data. These extracted or “learned” features are then provided to the aforementioned fingerprint database 410 for subsequent use in any of a number of classification, retrieval, and identification tasks involving another input signal 400. Note that the extraction of features from both the input signal 400, and the set of known data 405, is accomplished using an identical process. In other words, the feature extractor, once trained, extracts features from whatever signal is provided to it in the same manner, whether it is known data 405 used to create fingerprints for the fingerprint database, or data from a monitored signal 400 that is to be identified.

For example, in terms of audio fingerprinting, known data 405, such as, songs, commercials, station identifiers, etc., are first passed through the trained feature extraction module 340. This trained feature extraction module 340 then outputs features which are stored in the fingerprint database 410. Then, when a stream of audio is to be identified, that stream of audio is provided as an input signal 400 that is sampled at regular intervals and used for generating trace fingerprints. A feature comparison module 420 then compares the trace fingerprints generated from the samples to the fingerprints in the fingerprint database 410 for the purpose of identifying portions or segments of the audio input signal 400 corresponding to the fingerprints derived from the samples.

Further, as noted above, it is not necessary to provide a set of known data 405 (songs, commercials, etc.) to create fingerprints for identification. In particular, using only the input signal 400, repeat instances of objects embedded in the signal, or repeat instances of particular segments or portions of the signal are located by simply storing the features extracted from the sampled input signal, and searching through those features for locating or identifying matching features in subsequent samples of the input signal. Such matches can be located even though the identity or content of the signal corresponding to the matching features is unknown. Further, also as noted above, statistical information regarding such unknown matches, such as number of times played, station of play, time of play, etc., is easily gathered. Subsequent identification of the unknown objects, either via user identification, or subsequent comparison to an updated fingerprint database may also be used.

As noted above, trace fingerprints are computed at intervals from the input signal and are then compared with entries in the fingerprint database to locate matches. In one embodiment, an input trace fingerprint that is found in the fingerprint database is then confirmed by computing at least one additional fingerprint from the input signal for providing additional comparisons to the existing fingerprints in the database, thereby increasing overall system accuracy.

3.1.2 Fingerprint/Metadata Database:

The fingerprint/metadata database contains information including fingerprints for known objects of interest and metadata describing those objects. In one embodiment this information is included in a single database or electronic file. However, clearly, this information may be included in two or more linked databases or electronic files. In general, the fingerprint/metadata database, Dₘ, includes objects for which fingerprints have been pre-computed, and in which fingerprints and metadata (e.g., for songs, the name of the song, artist, album title, copyright year, music genre, etc.; and for commercials, the advertisement title, name of the advertised product; etc.) is available. As noted above, each incoming input signal is monitored by the fingerprint engine, which then produces trace fingerprints from sampled sections of that input signal. These trace fingerprints are then compared to the pre-computed fingerprints in the metadata database to locate matches.

Clearly, the reliability and accuracy of the interactive signal analyzer depends upon the reliability and completeness of the fingerprint/metadata database. For example, as more fingerprints of unique objects, such as songs or commercials that are provided in the fingerprint/metadata database, more correct identifications of objects will be made in any monitored input signal. However, as noted above, even where the identity of particular objects is not known, such objects can still be identified as unique repeating objects where that object was previously present in the monitored signal. In particular, as described above, in one embodiment, trace fingerprints that do not match entries in the fingerprint/metadata database are added to that database as unique unknown objects. Thus, each subsequent time that the object appears, it will be identified as a repeating object, and statistical information regarding that object will be collected and passed to the object/station database. Further, subsequent to analysis of the input signal, any unknown objects can be identified either manually, or by querying an updated fingerprint/metadata database.

3.1.3 Object Database:

Given a fingerprint engine such as the DDA-based fingerprint engine described above, identification of objects in one or more input signals serves as the basis for populating the aforementioned interactive object database. As noted above, when a match is identified via a fingerprint comparison, the metadata from the metadata database is attached to the portion of the stream then playing since it can be inferred that the object identified in the database is playing at that point in the stream. Note that the term “object database” is used interchangeably with the term “station database” in the following discussion, as a tested embodiment of the object database includes object identification and metadata describing each object identified in one or more FM radio broadcast streams. Further, as noted above, the discussion of FM radio audio streams is not intended to limit the interactive signal analyzer to use with radio signals. In fact, the interactive signal analyzer may be used with any desired type of signal, and the discussion of the interactive signal analyzer in the context of FM radio signals is provided simply as one example of tested embodiment of the interactive signal analyzer.

Therefore, using the concept of a radio station for purposes of discussion, once an object has been identified in the audio stream, the information describing that object, along with statistical information such as time and date played, the particular radio station on which it was played, etc., is stored to the object or “station” database, Dₛ. Further, in the embodiment where the audio stream is buffered or stored, a pointer to the position in the audio stream where the object was identified will also be stored to the object database along with the statistical information and metadata. This allows the user to immediately jump to a playback of the portion of the audio stream in which a particular object of interest, such as a song or commercial, was identified. Further, a copy of the sample used to generate the trace fingerprint from the input signal is also stored to the object database in one embodiment. One advantage of this embodiment is that the user is provided with a copy of the original segment of the incoming signal that was used to identify a particular match, thereby allowing the user to manually confirm such matches, or simply listen to that sample, if desired.

As noted above, if an object is detected more than once in an input signal, a counter for that object is incremented in the object database rather than creating a new entry for the already played object. Further, in one embodiment, the existing entry for that object in the Dₛ database is expanded to include the time and date of each new occurrence. Consequently, over time, the station database, Dₛ, will be populated with more and more information about the content that each monitored station plays.

In a tested embodiment of the interactive signal analyzer, it was observed that some stations play a limited collection of songs that are repeated fairly often, while others play larger collections. In either case, such stations will appear in the station database Dₛ with one or more entries, depending upon the number of objects played and identified. However, stations that are observed to play little or no music at all and consist mostly of talk programs that seldom repeat are significantly less likely to appear in the station database, Dₛ, except with respect to repeating objects such as commercials. After sufficient time has passed, typically on the order of about a few days, a fairly accurate representation of the type of content each monitored station plays will be available in the station database Dₛ. For example, if a station plays mostly music hits from the 1980's, the entries in Dₛ for this station will reflect this.

In addition, in a related embodiment, particular objects, such as, for example, commercials and station jingles, can be excluded from inclusion in the station database. In this embodiment, fingerprints for known commercials, advertisements, or station jingles, are included in the fingerprint database. For example, when an unwanted commercial is identified within the audio stream, rather then add information describing that commercial to the object database, a flag set in the metadata for that commercial is used to exclude the identified commercial from inclusion in the object database. This embodiment is particularly useful where the user is only interested in a particular type of content, such as songs, rather than all objects that might be identifiable in the audio stream.

3.1.4 Database Queries:

Any conventional type of database may be used for implementing the station database, Dₛ. However, the station database, Dₛ is designed to allow either user defined or predefined queries against the information collected in the database. As discussed above, user defined queries are either entered via a command line interface, or via a GUI. In addition, the predefined queries are provided via a GUI, including for example, a web-browser based user interface that allows for simple user selection of otherwise complex queries, with only limited input, if any, needed from the user. In order to make such queries both possible and efficient, in a tested embodiment, the station database, Dₛ was designed as a relational database using a conventional SQL database structure, such as, for example, Microsoft© SQL Server™. The use of a conventional SQL structure allows for complex queries of the data stored in the database, with the only real limitation to such queries being the scope of the metadata and statistical information being queried.

For example, by querying Dₛ, it is possible to gather any desired statistics, such as, for example, “Top 10” lists, songs by artist, artists played, frequency of songs, frequency of artist, times that particular songs or artists were played, etc., for each station. In addition, more complicated queries such as, for example, cross-station queries are also implemented via the GUI, or via command line entry of queries. In other words, it is possible to compare two or more stations by querying Dₛ. For example, questions such as “Which station plays the most <Pink Floyd>?” are readily posed by storing the data in a conventional SQL-type database. Using such a database, any of a number of desired database queries that may be of interest to users are easily answered using standard SQL query language. A few simple examples of such queries, with respect to music and music artists are provided below. Not that these example queries include terms in brackets, “< >”, that represent variables that are either selected or entered by the user. Further, it should be noted that these queries are not provided in an SQL query format, but are presented in plain text for purposes of explanation.

Which station plays the most <Pink Floyd>?

Show the top <25> most played artists on radio station <KXXX>.

Show the top <100> most played songs on radio station <KXXX>.

Show the top <5> songs played by <Pink Floyd> on all stations combined.

Show the top <1> songs played by <Pink Floyd> on radio station <KXXX>.

Show the artists that are played on <KXXX> but not on <KYYY>.

Show the artists that are played on both <KXXX> and <KYYY>.

Show all stations that played <Pink Floyd>.

Show the top <10> stations that played the most <Pink Floyd>.

Which station plays most music during the course of the day?

Which station plays the most music from <11:00 AM> to <4:00 PM>?

List the most common genres played on radio station <KXXX>.

List all genres played on radio station <KXXX>.

Which station plays the largest collection of music?

Graph the number of songs played per hour by radio station <KXXX>.

Show a pie chart by genre of the content played by radio station <KXXX>.

Etc.

Further, queries across the entire spectrum of a given medium may be of interest to a user, rather than just one type of object such as songs. For example, a few simple examples of other types of queries that can be made include:

What coverage did a particular commercial get, across the whole FM spectrum available in the <Seattle, Wash.> area, on day <X>?

What commercials preceded or followed a particular commercial, across the whole FM spectrum available in the <Seattle, Wash.> area, on day <X>?

What coverage did the audio clip of the President's speech containing the phrase <‘axis of evil’> get across all TV news stations on day <X>?

What coverage did the audio clip of the President's speech containing the phrase <‘axis of evil’> get across all TV news and radio stations on day <X>?

What TV news and radio stations on day <X> did not broadcast the audio clip of the President's speech containing the phrase <‘axis of evil’>?

How many songs were played between commercial breaks on radio station <KXXX> between <11:00 AM> to <4:00 PM>.

Etc.

3.1.5 Interactive User Interface:

As noted above, in one embodiment, users are presented with a user interface for implementing raw SQL queries against the station database, Dₛ. However, in another embodiment, rather than allowing clients to query the database Dₛ directly, an interactive graphical user interface (GUI), such as, for example, an HTML or Web-type interface having a set of predefined user accessible SQL queries is provided. This interactive GUI contains a number of structured queries that allows the user to input certain variables using conventional controls such as, for example, text input windows, dropdown lists, check boxes, radio buttons, etc. For example, referring back to the example query “Which station plays the most <Pink Floyd>?,” this question can be pre-written, while the variable <Pink Floyd> is input or selected via the user interface. Clearly, large numbers and types of queries can be requested by a user, posed in a structured form via the user interface, and translated into an SQL query for presentation to the station database Dₛ. A tested embodiment of a GUI for the interactive signal analyzer is described in Section 4.

3.1.6 Automatic Data Reports:

In the embodiments described above, a number of examples are provided which illustrate the use of an interactive user interface for providing responses to user selected or defined queries. In particular, the aforementioned examples illustrate scenarios where the user is requesting, or “pulling,” data from the server, either via direct database queries or through the GUI. However, in a related embodiment, the user is not required to request particular information or data each time that such information is desired. In fact, in one embodiment, information extracted by the interactive signal analyzer from one or more signals, such as a group of radio stations, is instead automatically sent, or “pushed,” to the user.

For example, in one such embodiment users are provided with information regarding one or more streams by subscribing to a service that automatically generates reports or data from an analysis of these streams, then pushes those reports or data to the user. By way of example, such information may include any of the information described above, such as a weekly snapshot of what a particular radio station played. This information is then automatically transmitted to the users computer. In one embodiment, this automatic transmission takes the form of an automatically generated report that is simply sent to a predefined user e-mail address. Clearly, any of the information described above may be automatically provided to one or more users without requiring the user to manually request that information.

3.2 System Operation:

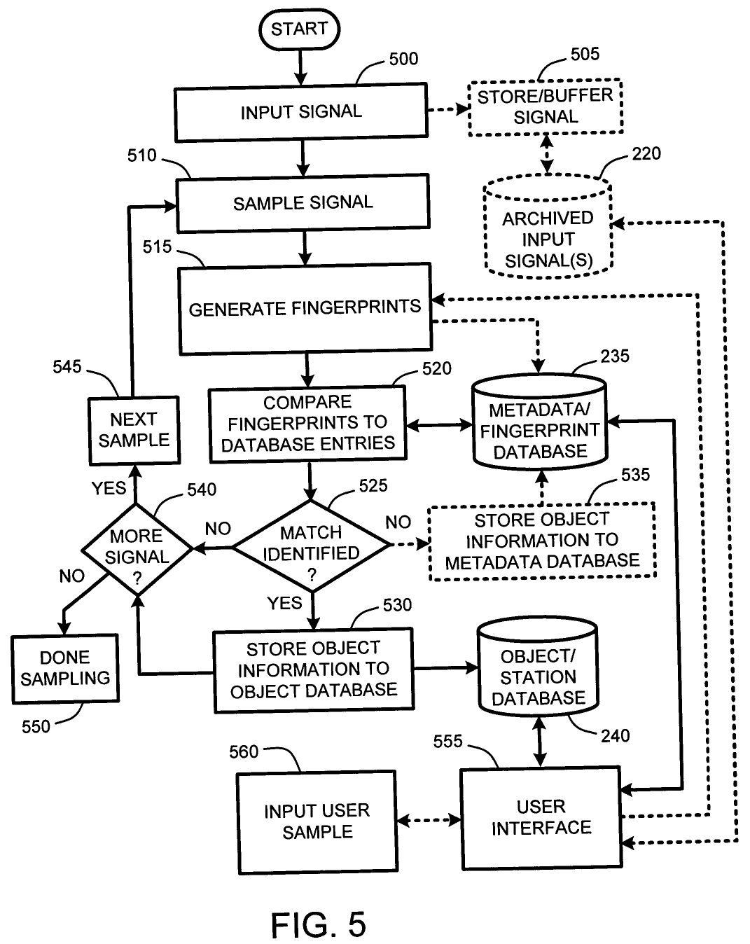

As noted above, the program modules described in Section 2.0 with reference to FIG. 2, and in view of the more detailed description provided in Section 3.1, are employed for automatically identifying and storing content information for sampled signals, and providing a user interface for allowing interactive user queries and display of the stored content information. This process is depicted in the flow diagram of FIG. 5, which represents several alternate embodiments of the interactive signal analyzer. It should be noted that the boxes and interconnections between boxes that are represented by broken or dashed lines in each of these figures represent further alternate embodiments of the interactive signal analyzer, and that any or all of these alternate embodiments, as described below, may be used in combination.

Referring now to FIG. 5 in combination with FIG. 2, in one embodiment, the process can be generally described as a system and method for identifying objects in one or more sampled signals, and providing an interactive user interface for interacting with statistical information and metadata describing objects identified within the sampled signals. In particular, as illustrated by FIG. 5, the interactive signal analyzer described herein begins by inputting one or more signals 500. In one embodiment, the input signals 500 are stored or buffered 505 to the archived input signal database 220.

Whether or not the input signals 500 are stored or buffered 505, they are then sampled 510. The size and period of the sample are dependent on both the length of any objects in the input signals 500, and the type of fingerprint engine being used. For example, the DDA-based fingerprint engine described above computes trace fingerprints 515 every 186 ms over samples of the input signal 500. Once the trace fingerprint has been generated 515 for a particular sample, that trace fingerprint is compared 520 to the fingerprints of known audio objects that are stored in the aforementioned metadata/fingerprint database 235. As discussed above, this metadata/fingerprint database 235 includes pre-computed fingerprints and metadata describing objects represented by the pre-computed fingerprints.

If a matching fingerprint is identified 525 in the metadata/fingerprint database 235, then the metadata associated with that matching fingerprint is stored 530 to the aforementioned object database 240, along with statistical information regarding the sample, such as the time that the identified object appeared in the input signal 500, and other information, as appropriate, such as the station, channel, frequency, etc. where the input signal was monitored. Further, in one embodiment, a copy of the sample extracted from the input signal 500 is also stored along with the statistical information and metadata. In a related embodiment, if a subsequent instance of a particular object is identified in the input signal, rather than creating a new entry in the object database 240, a counter representing the total number of identifications for that object of interest is simply incremented, and the statistical information documenting the time and source of the associated sample is stored to the object database.

If a matching fingerprint is not identified 525 in the metadata/fingerprint database 235, then a determination 540 is made as to whether the end of the input signal 500 has been reached. If the end of the signal has been reached, the system is done sampling 550, and the object/station database will have been populated with any objects identified in the input signal 500. However, if the end of the signal has not yet been reached, a next sample 545 is simply extracted from the input signal 500 and used to generate a new trace fingerprint 515 which is then compared 520 to fingerprint entries in the metadata/fingerprint database 235, as described above.

Alternately, in another embodiment, if a matching fingerprint is not identified 525 in the metadata/fingerprint database 235, then information characterizing the current sample, i.e., the trace fingerprint generated from that sample, and the time and source of the signal from which the sample was extracted, is stored to the metadata/fingerprint database 235 as an “unknown object” entry, along with either a copy of the sample, or a pointer to a location in the input signal where the sample was taken. Further, any statistical information available for the sample, such as, for example, the broadcast time of the sample, and the source of the signal, is also stored to the metadata/fingerprint database 235. Therefore, any subsequent occurrences of an object having a matching fingerprint will be identified, as the metadata/fingerprint database 235 will include a fingerprint entry for that unknown object. In this case, both the first instance of the unknown object, and each subsequent instance, will then be added to the object database 240 along with any statistical information that is available for that object.

In one embodiment, entries of unknown objects in the object database 240 are identified simply by a number or other unique identifier, such as, for example “Unknown #1,” “Unknown #2,” etc. Further, as described in further detail below, metadata such as an object title or other information may be assigned to one or more of the unknown objects in either the metadata/fingerprint database 235, or the object database 240 via a user interface 555. In this embodiment, any metadata updated or edited by the user in one database will be automatically updated in the other database.

At any time during the steps described above, the user interface 555 provides for user access to, and interaction with, the object database 240, the metadata/fingerprint database 235, and, in one embodiment, to the archived input signals 220. Further, as described above, in another embodiment the user interface also provides the capability to enter one or more samples 560 of objects that the user wishes to be identified in the input signal 500. Trace fingerprints are automatically generated 515 from these user supplied samples 560. The fingerprints generated from these user supplied samples 560 are then stored to the metadata/fingerprint database 235 for use in identifying subsequent instances of the newly fingerprinted object within the input signal 500.

Note that this user interface 555 and interaction is described in further detail above in sections 3.1.4 and 3.1.5. Further, an example of a tested embodiment of the user interface 555 is described in detail in Section 4 with respect to monitoring one or more FM radio stations as the input signal 500.

4.0 Tested Embodiment:

The following discussion provides an example of an interactive signal analyzer system that uses a DDA-based fingerprint engine to analyze the content across a broadcast FM radio spectrum using one or more tunable radio receivers. Note that the system described is equally applicable to any broadcast audio signal, including, for example, satellite radio, Internet or other network audio broadcasts, or an audio signal in a combined audio/video broadcast such as a television signal.

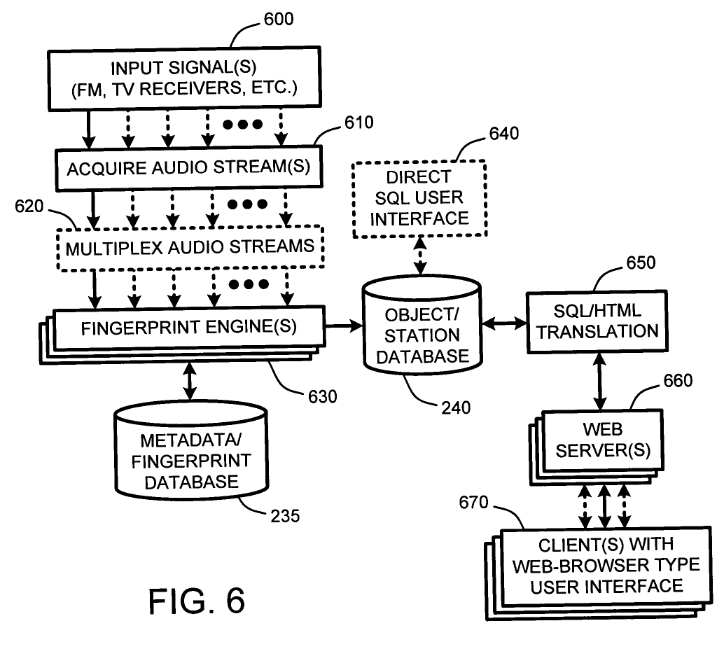

In general, as illustrated by FIG. 6, a tested embodiment of the interactive signal analyzer uses one or more conventional receivers 600 to acquire 610 one or more channels of broadcast audio. This broadcast audio 610 is then sampled and provided to a fingerprint engine 630 to identify the content of the broadcast audio through comparison to fingerprints of known audio objects in the metadata database 235 on a station by station basis. Metadata and statistical information describing objects identified via the comparison are then stored to the object database 240. The object database 240 is provided in a conventional SQL-type format so as to allow for complex queries of the information stored in the object database. Further, one or more web servers 660 then accept queries from one or more client computers via a client user interface 670. These queries are then passed to a layer that translates the client queries into SQL queries for querying the object database 240. The results of the queries are then provided back to the client 670, again via the web servers 660.

In this tested embodiment, one or more input signals 600 are acquired 610 by using one or more computers, each computer having one or more tunable receivers to monitor at least one FM radio station. In a related embodiment, multiple computers and tuners are used to monitor some or all FM stations receivable within one or more geographic regions. Clearly, this embodiment is extensible to the case where all FM radio broadcasts are monitored in all geographic regions. In another related embodiment, rather than dedicate a particular computer/tuner combination to a particular channel, one or more of the computer/tuner combinations are designed to automatically switch frequencies and monitor two or more particular frequencies for predetermined periods at predetermined intervals.

As described above, it is not necessary to continuously monitor a radio station in order to identify objects such as songs being broadcast on that radio station. In particular, because computation of trace fingerprints from audio information can be made using a relatively small portion of an audio object in the audio stream, monitoring each frequency or radio station for a few seconds before switching to the next radio station is typically sufficient to catalog the contents of the broadcast of any particular radio station. However, as noted above, monitoring of each radio station should occur at least once during a time period equal to about one-half the expected length of objects being identified in the radio broadcast.

For example, in one embodiment a programmable tunable FM receiver is used to hop between two or more FM radio channels. Further, as described above, the DDA-based fingerprint engine described herein does not require constant monitoring or access to the audio stream, as it can successfully identify objects from relatively short portions of an audio object such as a song, commercial, or station identifier. In this embodiment, the broadcast audio streams 610 of several stations are multiplexed 620 to enable a single fingerprint engine to concurrently handle several radio stations. In this way, the number of receivers needed to cover a relatively large geographic region can be reduced. In particular, in this embodiment, the stream from one or more received channels is not sampled continuously, but rather is sampled for some fixed interval, and then not sampled at all for some time. This embodiment provides the advantage of a reduced number of computers and receivers for monitoring multiple stations at the cost of possibily failing to detect one or more objects in any particular stream. However, even though lossy, this embodiment is sufficient to generate an accurate statistical picture of the contents of each stream over time.

Whichever of the radio monitoring embodiments described above are used, the basic premise is that an audio stream 610 is captured and made available on one or more computers having an instance of a fingerprint engine 630. The incoming audio stream or streams 610 are then provided to one or more instances of the fingerprint engine 630 which then produces trace fingerprints from sampled sections of the audio stream. The fingerprint engine 630 then determines the name and other metadata (artist, length, etc.), and statistical information (station, date and time played, etc.) of any song, or other identified repeating object that occurs in the audio stream through a comparison to matching entries in the metadata/fingerprint database 235. The metadata and statistical information for matching objects is then stored to the object database 240.

The process described above is repeated on as many radio stations as desired in one or more geographic reception areas to identify some or all of the content that is broadcast across the entire FM spectrum. In one embodiment, this process is implemented in parallel using different receivers to monitor all of the stations simultaneously. However, this embodiment requires the use of as many receivers and fingerprint engines as stations being monitored, though it would still require only one metadata database 235 and one station or object database 240.

As noted above, an interactive user interface is provided for interacting with the object database 240. In one embodiment, a direct command line type user interface 640 is provided for directly entering SQL queries for querying the object database 240. However, as noted above, in another embodiment, the object database 240 is remote from one or more clients. For example, in a tested embodiment, the object database 240, and all of the information that it contains is instantiated on a server computer that is accessible to one or more client computers via a web-browser type GUI 670 that operates across one or more conventional web servers 660. In displaying the below described windows and information comprising the user interface, it should be noted that each window is populated based on information that is dynamically retrieved from the object database 240.

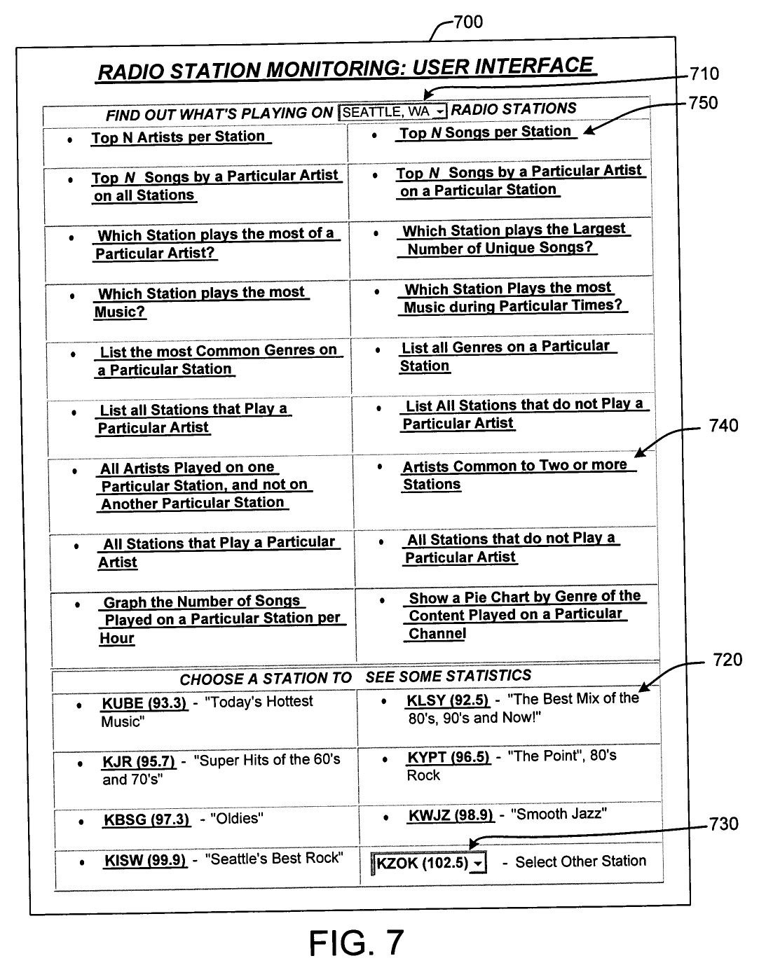

Examples of the web-browser type GUI are provided in FIG. 7 through FIG. 10, in view of FIG. 5 and 6. For example, the GUI 700 of FIG. 7 provides for client access to, and interaction with, the object database 240 using predefined and user selectable queries of the object database 240. As described above, this web-browser based GUI is provided across a network such as the Internet to allow one or more remote clients to interact with the interactive signal analyzer via one or more servers 660.

As illustrated by FIG. 7, in one embodiment, a “radio station monitoring” user interface 700 is provided. This user interface 700 uses conventional controls, such as hyperlink type user selectable queries, and dropdown lists for user selection of variables, to provide a dynamic interactive interface to the information in the object database 240. For example, as described above, the interactive signal analyzer is capable of monitoring one or more radio stations in one or more geographic regions. Consequently, user selection of a geographic region of interest is provided via a conventional dropdown list 710. Upon user selection of a particular region, such as, for example, Seattle, Washington, user selection of subsequent query items will be limited to the specified geographic region.

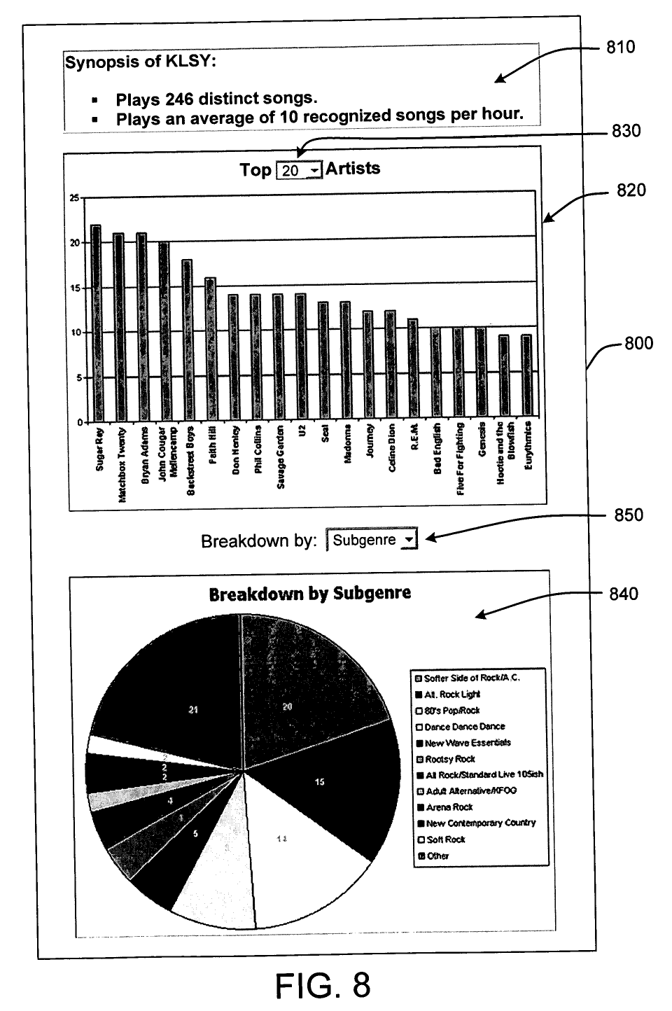

Further, upon user selection of a particular region, links 720 to statistical information for one or more popular radio stations in the selected region are automatically provided. Selection of a new geographical region 710 will cause these links 720 to be dynamically updated to reflect the currently selected region. In addition, a conventional dropdown list 730 for user selection of other radio stations in the selected region is also provided. User selection of a particular radio station, either via one of the hyperlinks 720, or via the dropdown list 730 serves to automatically call up a display window that provides a synopsis of some of the statistics gathered for the selected radio station. For example, as illustrated by FIG. 8, this display window 800 includes a synopsis listing 810 of the total number of songs identified by the fingerprint engine, and an average number of recognized songs per hour.

In addition, this display window 800 also lists the top N artists for that radio station, with N being a user selectable number 830. Upon user selection of the number of top artists to display, a bar chart 820 listing the top N artists is automatically generated, with the artists displayed in order of the total number of songs played. Further, the display window 800 also includes a breakdown 840 of the type of content being played on the selected radio station. In particular, user selection of a type of breakdown via a dropdown list 850 allows the user to select a content breakdown by music “Genre,” music “Subgenre,” or music “Mood.” As illustrated in FIG. 8, selection of the “Subgenre” item via the dropdown list 850 automatically displays a breakdown by subgenre of the types of music played on the selected radio station in a pie chart format. Note that information such as music genre or subgenre is included in the metadata that is associated with particular entries in the object database. This information is then extracted from the object database 240 in response to user selection of the breakdown type via the dropdown list 850.

Referring back to FIG. 7, as noted above, the exemplary user interface 700 includes a number of predefined hyperlink type user selectable queries, such as, for example, “Artists Common to Two or more Stations” 740, or “Top N Songs per Station” 750. Clearly, hyperlink based queries may be predefined for any information available in the object database 240 and presented to the user via the user interface 700. User selection of such links will automatically be forwarded as an SQL query to the object database 240, which will then return the requested information to the client 670 for display.

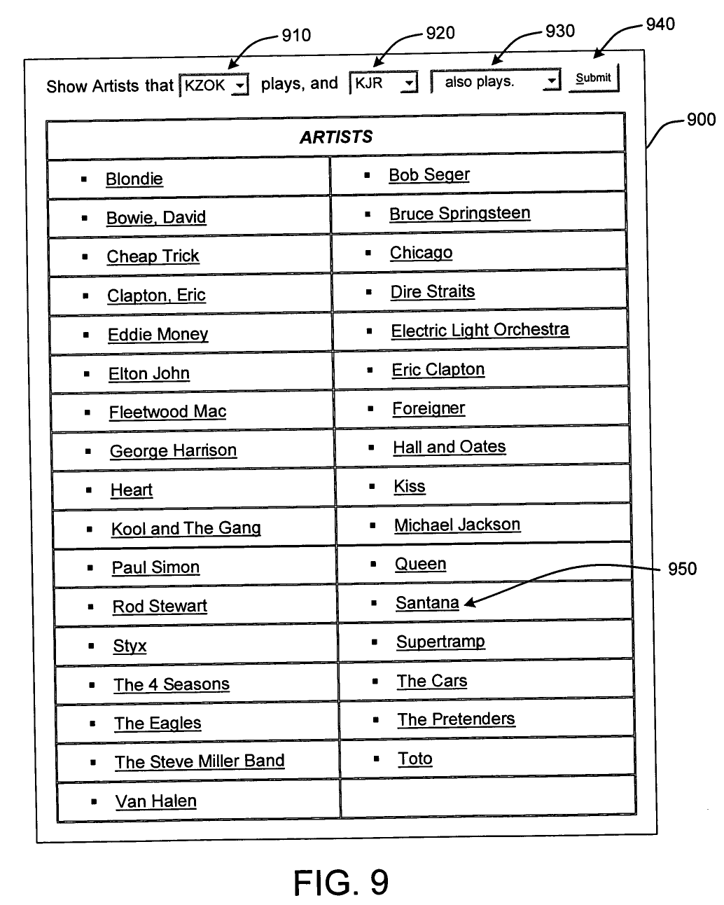

For example, user selection of the hyperlink “Artists Common to Two or more Stations” 740 will automatically call up a dynamic artist display window 900, as illustrated by FIG. 9. The dynamic artist display window of FIG. 9 provides a list of artists that are played on one or more radio stations. For example, dropdown lists, 910 and 920, are provided for selecting a first and second radio station, respectively. Further, a third dropdown list 930 is provided for user selection of an option describing whether the displayed artists were played on both radio stations (i.e., selection of an “also plays” option) or is played on the first station, but not the second station (i.e., selection of a “does not play” option). Basically, the “also plays” option is equivalent to a Boolean AND operation, such that the artist is only listed if both stations play that artist. Similarly, the “does not play” option is a simple Boolean operation that only lists an artist that is played by the first station, but not by the second station.

Each time that the user makes a selection of a different radio station via one of the dropdown lists, 910 or 920, or makes a selection via the third dropdown list 930, then presses a “Submit” button 940, a query is automatically sent to the object database 240 which returns artist information fulfilling the query. This information is then used to dynamically populate a table of artists as illustrated by the dynamic artist display window 900. Further, in one embodiment, each of the displayed artist names is provided as a user selectable hyperlink. For example, user selection of an artist name “Santana” 950 will call up a display window listing the songs played by that artist on either or both the first and second stations, depending upon the option selected via the third dropdown list 940 (e.g., “also plays,” or “does not play”).

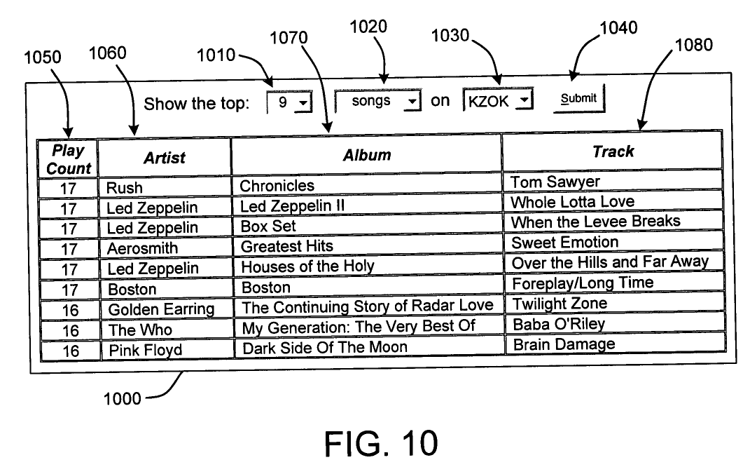

Referring back to FIG. 7, user selection of the hyperlink “Top N Songs per Station” 750 will automatically call up a dynamic “most played” window 1000, as illustrated by FIG. 10. The dynamic “most played” window 1000 of FIG. 10 provides a list of a user selectable number of the most frequently played songs or artists on a user selected radio station. In particular, as illustrated by FIG. 10, a first dropdown list 1010 is provided for selecting a number of top songs or artists to display. Next, a second dropdown list 1020 is provided for selecting either “Songs” or “Artists.” Finally, a third dropdown 1030 is provided for user selection of the radio station of interest.

Once user selection of the items represented by the three dropdown lists, 1010, 1020, and 1030, has been completed, user selection of a “Submit” button 1040 automatically sends a query to the object database 240 which returns song or artist information for populating the “most played” window 1000. For example, as illustrated by FIG. 10, user selection of <9> <songs> on <KZOK> returns a dynamic table that is populated with information corresponding to a total play count 1050, an artist name 1060, and album name 1070, and finally, a track name 1080 for the nine most played songs on the selected radio station. Selecting new options via one of the dropdown lists, 1010, 1020, or 1030, and selecting the submit button 1040 will initiate a new query to the object database, and a dynamic repopulation of the “most played” window 1000.

Clearly, a very large number of predefined queries may be provided to each client 670 (see FIG. 6). These queries are not intended to be limited to the user interface and query examples provided above. In fact, it should be clear that in view of the preceding discussion, the possible queries are limited only by the metadata and statistical information associated with each identified or unknown object in the object database 240, and any potential combinations of that metadata and statistical information.

The foregoing description of the invention has been presented for the purposes of illustration and description. It is not intended to be exhaustive or to limit the invention to the precise form disclosed. Many modifications and variations are possible in light of the above teaching. Further, it should be noted that any or all of the aforementioned alternate embodiments may be used in any combination desired to form additional hybrid embodiments of the interactive signal analyzer described herein. It is intended that the scope of the invention be limited not by this detailed description, but rather by the claims appended hereto.

What is claimed is:

1. A computer-implemented process for providing an interactive user interface to a database of information describing contents of an input signal, comprising:
extracting at least one fingerprint from each of at least one sample of at least one input signal;
comparing the extracted fingerprints to known fingerprints in a database of fingerprints of known signal objects to locate matching fingerprints for identifying one or more objects embedded in the at least one input signal as a known signal object;
storing one or more extracted fingerprints that do not match any fingerprints in the database of fingerprints to the database of fingerprints as an unknown object fingerprint for use in matching subsequent instances of repeating objects in the at least one input signal;
in an object database, storing statistical information derived from the at least one input signal for each sample having an extracted fingerprint that matches a known fingerprint; and
providing an interactive user interface for querying the statistical information in the object database.

2. The computer-implemented process of claim 1 wherein the database of fingerprints includes metadata corresponding to information describing attributes of fingerprints in the database of fingerprints.

3. The computer-implemented process of claim 2 further comprising:
extracting any metadata and statistical information associated with any extracted fingerprints that match an entry in the database of fingerprints; and
storing the extracted metadata to the object database for each sample having an extracted fingerprint that matches a fingerprint of a known signal object.

4. The computer-implemented process of claim 1 wherein the at least one input signal comprises one or more FM radio station broadcast signals in one or more geographic regions.

5. The computer-implemented process of claim 1 wherein the at least one input signal comprises one or more television broadcast signals in one or more geographic regions.

6. The computer-implemented process of claim 1 wherein the at least one input signal comprises one or more cable video signals in one or more geographic regions.

7. The computer-implemented process of claim 1 wherein the at least one input signal comprises one or more FM radio station broadcast signals in one or more geographic regions.

8. The computer-implemented process of claim 1 wherein the at least one input signal comprises one or more Internet multimedia streams.

9. The computer-implemented process of claim 4 further comprising multiplexing two or more FM radio station broadcast signals into a single input signal prior to extracting the at least one fingerprint from that single input signal.

10. The computer-implemented process of claim 1 wherein the at least one input signal comprises at least one user selectable FM radio station broadcast signals in one or more geographic regions.

11. The computer-implemented process of claim 1 further comprising buffering the at least one input signal for a predetermined period of time.

12. The computer-implemented process of claim 1 further comprising storing the at least one input signal on a computer readable medium.

13. The computer-implemented process of claim 1 further comprising, obtaining at least one signal sample via the user interface;
extracting a sample fingerprint from each signal sample;
adding each sample fingerprint to the database of fingerprints; and
identifying one or more objects embedded in the at least one input signal by comparing the extracted fingerprints to sample fingerprints added to the database of fingerprints.

14. The computer-implemented process of claim 1 wherein the interactive user interface is a web-browser based user interface for performing user queries of the object database across the Internet.

15. The computer-implemented process of claim 1 further comprising identifying one or more objects embedded in the at least one input signal as an unknown object by comparing the extracted fingerprints to unknown object fingerprints in the database of fingerprints of known and unknown signal objects to locate matching fingerprints.

16. The computer-implemented process of claim 1 wherein the interactive user interface for querying the statistical information in the object database comprises at least one predefined user selectable database query.

17. The computer-implemented process of claim 1 wherein the object database is implemented on at least one local server computer and the interactive user interface is provided on at least one remote client computer accessible via the Internet for providing remote client interaction with the local object database.

18. The computer-implemented process of claim 1 further comprising automatically generating at least one set of information for characterizing at least one of the input signals, and automatically transmitting that set of information from a server computer to at least one client computer.

19. The computer-implemented process of claim 1 wherein sampling of a particular input signal is suspended for a period of time when an object embedded in that input signal is identified in that signal, and where the period of time is either predetermined or is determined by the characteristics of the identified object.

20. The computer-implemented process of claim 1 wherein extracting at least one fingerprint from each of at least one sample comprises performing a distortion discriminant analysis of each sample to generate fingerprints.

21. The computer-implemented process of claim 1 further comprising a user interface for inputting at least one user specified signal sample, and wherein fingerprints are automatically extracted from each user specified signal sample and added to the known fingerprints in the database of fingerprints.

22. The system of claim 17 further comprising a user interface for entering metadata associated each user specified signal sample.

23. A system for determining content of multiple media streams in real time, comprising:
simultaneously monitoring two or more media streams in real time;
sampling each media stream;
deriving a signal fingerprint from each sample from each media stream;
comparing each signal fingerprint to a fingerprint database, said fingerprint database including known fingerprints of known media objects and metadata information describing the known media objects;
identifying one or more media objects by locating matching fingerprints of known media objects to each signal fingerprint;
populating an object database residing on at least one local server computer with statistical information derived from each identified media object, and with any metadata associated with the matching fingerprint of any known media objects; and
providing an interactive user interface for allowing at least one remote client computer to interact across a network with the object database residing on the at least one local server computer.

24. The system of claim 23 wherein the network is the Internet.

25. The system of claim 23 wherein the media objects are any of songs, music, advertisements, commercials, station identifiers, speech audio clips, and emergency broadcast signals.

26. The system of claim 23 wherein the two or more media streams comprise television broadcast signals.

27. The system of claim 23 wherein the two or more media streams comprise cable multimedia broadcast signals.

28. The system of claim 23 wherein the two or more media streams comprise Internet multimedia streams.

29. The system of claim 23 wherein the two or more media streams comprise automatically selected FM radio station broadcast signals in one or more geographic regions.

30. The system of claim 23 wherein the two or more media streams comprise user selectable FM radio station broadcast signals in one or more geographic regions.

31. The system of claim 23 further comprising simultaneously applying separate fingerprint extraction engines to each media stream for deriving the signal fingerprint for each sample from each media stream.

32. The system of claim 29 further comprising monitoring at least one automatically tunable receiver, wherein each automatically tunable receiver automatically switches between at least two radio broadcast streams at predefined intervals and samples each of the at least two radio broadcast streams for a predefined period of time.

33. The system of claim 31 further comprising multiplexing the samples from each automatically tunable receiver into a separate multiplexed radio broadcast stream.

34. The system of claim 33 wherein deriving the signal fingerprint for each sample from each radio stream comprises simultaneously operating a separate fingerprint extraction engine for each multiplexed radio broadcast stream for deriving the signal fingerprint for each sample comprising each multiplexed radio broadcast stream.

35. The system of claim 29 further comprising monitoring at least one automatically tunable receiver, wherein each automatically tunable receiver automatically switches between at least two radio broadcast streams at intervals that are defined by what has been identified.

36. The system of claim 35 further comprising multiplexing the samples from each automatically tunable receiver into a separate multiplexed radio broadcast stream.

37. The system claim 23 wherein the interactive user interface comprises at least one predefined user selectable query for querying any statistical information and metadata in the object database.

38. The system of claim 37 wherein the at least one predefined user selectable query includes a query for displaying user selectable music artist statistical information with respect to one or more user selectable media streams.

39. The system of claim 37 wherein the at least one predefined user selectable query includes a query for displaying statistical content information with respect to at least one user selectable media streams.

40. The system of claim 37 wherein the at least one predefined user selectable query includes a query for displaying statistical music artist information with respect to at least one user selectable media streams.

41. The system of claim 37 wherein the at least one predefined user selectable query includes a query for displaying statistical commercial information with respect to at least one user selectable media streams.

42. The system of claim 23 further comprising storing each monitored media stream for a predetermined period of time

43. The system claim 23 wherein the interactive user interface further comprises a user selectable control for automatically providing a playback of at least one user selectable media object identified in one or more of the media streams.

44. The system claim 23 wherein the interactive user interface further comprises a control for adding a user selectable media sample corresponding to a user identified media object, and wherein a signal fingerprint is automatically derived from the user selectable media sample and added to the fingerprint database along with user entered metadata for describing the user selectable media sample.

45. The system of claim 23 wherein further comprising automatically adding any fingerprints derived from each sample to the fingerprint database where the derived fingerprints do not match any signal fingerprints in the fingerprint database.

46. The system of claim 23 further comprising automatically compiling a predetermined set of information from the object database, and automatically pushing that information from at least one of the local server computers to at least one of the remote client computers.

47. The system of claim 23 wherein deriving a signal fingerprint from each sample from each media stream comprises applying a distortion discriminant analysis to each sample for deriving a trace representing a signal fingerprint from each sample.

48. The system of claim 23 further comprising a user interface for inputting at least one user media sample and associated metadata for describing each user audio sample.

49. The system of claim 48 further comprising automatically deriving a signal fingerprint from each user media sample, and storing that fingerprint and any associated metadata in the fingerprint database.

50. A method for providing an interactive user interface for querying a database of content information that characterizes at least one signal, comprising:
monitoring at least one user selectable media broadcast signal common to a user selectable geographic region using at least one automatically tunable receiver;
sampling each broadcast signal for any of predefined periods of time and for periods of time determined by media objects identified in the at least one broadcast signal;
deriving a media object trace fingerprint from each sample, using a separate instance of a fingerprint engine for each receiver for simultaneously processing each monitored broadcast signal in real-time;
comparing each media object trace fingerprint to a fingerprint database, said fingerprint database including known fingerprints of known media objects, metadata information describing the known media objects, and fingerprints of unknown objects for identifying unknown but repeated objects;
identifying one or more media objects in one or more of the broadcast signals by comparing each media object trace fingerprint to the known fingerprints in the fingerprint database to locate matching fingerprints of known media objects;
populating an object database residing on at least one local server computer with statistical information derived from each identified media object, and with any metadata associated with the matching fingerprint of any known media objects; and
providing an interactive user interface for allowing at least one remote client computer to interact across a network with the object database residing on the at least one local server computer.

51. The method of claim 50 wherein the unknown but repeated objects are themselves stored in an unknown object database, and further comprising analyzing the unknown but repeated objects to determine metadata describing the unknown but repeating objects, said metadata then being entered in the fingerprint database.

52. The method of claim 51 wherein analyzing the unknown but repeated objects to determine metadata comprises manual user identification and entry of the metadata for one or more of the repeated objects via the interactive user interface.

53. The method of claim 51 wherein analyzing the unknown but repeated objects to determine metadata comprises automatically identifying the unknown but repeated objects by comparing the objects to at least one additional object database, and importing any metadata associated with the automatically identified unknown but repeated objects into the fingerprint database.

54. The method of claim 50 wherein the at least one user selectable broadcast signal is a radio station

55. The method of claim 50 wherein the at least one user selectable broadcast signal is any of a television broadcast signal, an internet broadcast signal, a network broadcast signal, and a cable broadcast signal.

56. The method of claim 50 wherein the network is the Internet.

57. The method of claim 50 wherein the object database is an SQL database.

58. The method of claim 50 wherein the interactive user interface comprises at least one predefined user selectable query for retrieving statistical information and metadata from the object database by user selection of the predefined user selectable query.

59. The method of claim 50 wherein media objects include any of music, advertisements, commercials, station identifiers, speech audio clips, videos, and emergency broadcast signals.

60. The method of claim 50 wherein metadata includes any of radio station call signs, music titles, song titles, music artist names, music album titles, commercial titles, commercial product information, and video titles.

61. The method of claim 50 wherein statistical information includes any of media object play times, media object play dates, media object play station, and media object number of plays.

62. The method of claim 55 wherein the user selectable query includes SQL queries for extracting information relating to the media objects, metadata, and statistical information in the object database.

63. The method of claim 50 wherein the interactive user interface is a web-browser based user interface.

64. The method of claim 50 further comprising automatically generating at least one report comprising statistical and metadata for describing one or more of the media broadcast signals.

65. The method of claim 64 further comprising automatically transmitting the at least one report to at least one of the remote client computers.

66. The method of claim 50 wherein deriving the media object trace fingerprint from each sample comprises applying a distortion discriminant analysis to each sample for deriving a trace representing the media object trace fingerprint from each sample.
